(19) United States
(12) Patent Application Publication
(10) Pub. No.: US 2025/0346716 A1
(43) Pub. Date: Nov. 13, 2025

(54) POLYMER NANOCOMPOSITES AND METHODS OF USE THEREOF

(71) Applicant: ARIZONA BOARD OF REGENTS ON BEHALF OF ARIZONA STATE UNIVERSITY, Scottsdale, AZ (US)

(72) Inventors: Soyoung Seo, Phoenix, AZ (US); Jen-Chieh Yu, Tempe, AZ (US)

(21) Appl. No.: 18/645,069

(22) Filed: Apr. 24, 2024

Related U.S. Application Data
(60) Provisional application No. 63/462,471, filed on Apr. 27, 2023.
(60) Provisional application No. 63/566,002, filed on Mar. 15, 2024.

(51) Int. Cl. C08G 69/48; C08F 16/06; C08G 71/04; C08J 7/12; C08K 3/04; C08K 3/08

(52) U.S. Cl. CPC C08G 69/48; C08F 16/06; C08G 71/04; C08J 7/12; C08K 3/041; C08K 3/08; C08K 2003/0806; C08K 2003/0831

(57) ABSTRACT

The present disclosure encompasses polymer nanocomposites and methods of use thereof.

This application claim priority to U.S. Provisional Application No. 63,462,471, filed on Apr. 27, 2023, and U.S. Provisional Application No. 63/566,002, filed on Mar. 15, 2024, the entire contents of each of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present disclosure encompasses polymer nanocomposites and methods of use thereof.

### BACKGROUND OF THE INVENTION

Self-healing materials with dynamic bonds can be useful in a variety of applications.

### SUMMARY OF THE INVENTION

Aspects of the invention are drawn towards a dynamic polymer nanocomposite comprising: a nanoparticle; a polymer comprising a hydrogen bonding moiety sidechain; and a small molecule ligand, wherein the ligand comprises an anchoring moiety to functionalize the nanoparticle, a spacer region, and a hydrogen bonding moiety; and a polymer comprising a hydrogen bonding moiety side chain complementary to the small molecule ligand hydrogen bonding moiety. In embodiments, the nanoparticle is selected from the group consisting of a gold nanoparticle (AuNP), a silver nanoparticle (AgNP), a silica nanoparticle (SiNP), a carbon nanotube, an iron oxide nanoparticle, or a micellular nanoparticle. In embodiments, the polymer is selected from the group consisting of polyacrylamide, a polyurethane, a polyethylene terephthalate, nylon, a polycarbonate, a polyacrylate, a poly(acrylic acid), or a poly(vinyl alcohol). For example, the polyacrylamide is poly(N,N′-dimethylacrylamide) (PDMA). In embodiments, the polymer hydrogen bonding moiety side chain complementary to the small molecule ligand hydrogen bonding moiety is selected from the group consisting of —COOH, —NH₂, —OH, an amide, or a carbonyl. In embodiments, the small molecule ligand linker anchoring moiety is selected from the group consisting of a thiol, a silane, a carboxylic acid, a carbonyl, or an amine. In embodiments, the small molecule ligand is a catechol-based molecule. In embodiments, the small molecule hydrogen bonding moiety is selected from the group consisting of —COOH, —NH₂, —OH, an amide, or a carbonyl. In embodiments, the small molecule ligand is a thiol fatty acid or ester. In embodiments, the thiol fatty acid or ester is 11-mercaptoundecanoic acid or methyl 3-mercaptopropionate.

Aspects of the invention are drawn towards a method of synthesizing a dynamic polymer nanocomposite, the method comprising: dispersing at least one nanoparticle (NP) in an aqueous solution, thereby producing a NP dispersion; adding a polymer comprising a hydrogen bonding moiety sidechain into the NP dispersion thereby producing a polymer-NP mixture; (c) removing the aqueous solution from the polymer-NP mixture; (d) introducing an organic solvent into the polymer-NP mixture; and (e) adding a small molecule ligand (MUA) into the polymer-NP, wherein the small molecule ligand comprises an anchoring moiety to functionalize the NP, a spacer region, and a hydrogen bonding moiety complementary to the polymer binding moiety, thereby assembling to form a dynamic polymer nanocomposite. In embodiments, the polymer is selected from the group consisting of a polyacrylamide, a polyurethane, a polyethylene terephthalate, nylon, a polycarbonate, a polyacrylate, a poly(acrylic acid), or a poly(vinyl alcohol). For example, the polyacrylamide is poly(N,N′-dimethylacrylamide) (PDMA). In embodiments, the anchoring moiety is selected from the group consisting of a thiol group, a silanol group, a carboxylic acid group, a carbonyl group, or an amine group. In embodiments, the spacer region is selected from the group consisting of an alkyl chain, an ethylene glycol, or a poly(ethylene glycol). In embodiments, the organic solvent is chloroform. In embodiments, the nanoparticle comprises a gold nanoparticle (AuNP), a silver nanoparticle (AgNP), a silica nanoparticle (SiNP), a carbon nanotube, an iron oxide nanoparticle, or a micellular nanoparticle. In embodiments, the method further comprises tuning the polymer nanocomposite glass transition temperature (T_{g}) by increasing the nanoparticle concentration in step (a) and the MUA concentration in step (e), thereby increasing the interfacial binding interactions and increasing the T_{g}. In embodiments, the method further comprises tuning the polymer nanocomposite stress-relaxation rate by increasing the nanoparticle concentration in step (a) and the MUA concentration in step (e), thereby increasing the interfacial binding interactions and increasing the relaxation rate.

Aspects of the invention are drawn towards a polymer nanocomposite produced by a method described herein.

Other objects and advantages of this invention will become readily apparent from the ensuing description.

### BRIEF DESCRIPTION OF THE FIGURES

FIG. 1 shows a non-limiting, exemplary schematic and data of embodiments of the disclosure. (Panel a) Schematic of a polymer nanocomposite with complementary interfacial hydrogen bonding interactions between polymer and nanoparticle. (Panel b) UV-vis spectra of gold nanoparticles before and after the solvent exchange, indicating nanoparticles do not aggregate during and after the assembly process in the solution and solid phases.

FIG. 2 shows non-limiting, exemplary graphs of data. (Panel a) TGA graphs of polymer nanocomposites dried at three different temperatures. (Panel b) The T_{g} of polymer nanocomposites containing 5.92×10⁻³ v % nanoparticles decreases with increasing moisture content. The moisture content is determined by the weight decrease around 100° C. using TGA.

FIG. 3 shows non-limiting, exemplary data and schematics described herein. Panel (a) The T_{g} of polymer nanocomposites with different nanoparticle sizes and different ligand molar ratios. The stress-relaxation curve of the nanocomposites with Panel (b) 5 nm nanoparticles and Panel (c) 18 mu nanoparticles measured at 35° C. and fitting with Kohlrausch's stretched-exponential relaxation model. Panel (d) The characteristic relaxation time of polymer nanocomposites with different ligand densities. The nanoparticle concentration is 0.53×10⁻³ v % for 18 nm nanoparticles and 5 nm nanoparticles have the same particle number as 0.53×10⁻³ v % of 18 nm nanoparticles.

FIG. 4 shows non-limiting, exemplary graphs of data. (Panel a) T_{g} and (Panel b) storage modulus of polymer nanocomposites with different nanoparticle concentrations. (Panel c) Stress-relaxation curve at 35° C. and fitting with Kohlrausch's stretched-exponential relaxation model. (Panel d) Characteristic relaxation time with different nanoparticle concentrations.

FIG. 5 shows a non-limiting, exemplary schematic and images of embodiments described herein. (Panel a) Schematic of the fractured surface of the polymer nanocomposite designed and synthesized in this work for self-healing experiment. (Panel b) Self-healing occurs in polymer nanocomposite in 30 s by surface wetting or heating. The nanoparticle concentration shown in FIG. 5 is 5.92×10⁻³ v %. Self-healing can be demonstrated for a range of nanoparticle concentrations and ligand ratios.

FIG. 6 shows non-limiting, exemplary embodiments of the disclosure. (Panel a) Solid-phase polymer nanocomposites can be disassembled in their good solvent (excess water in this case). Gold nanoparticles and poly(N,N-dimethyl acrylamide) (PDMA) can be separated by centrifugation. (Panel b) NMR spectra of precipitate and supernatant after nanocomposite disassembly. (Panel c) UV-vis spectra of the initial citrate-capped AuNPs and the precipitated functionalized AuNPs after nanocomposite disassembly. The nanoparticle concentration is 5.92×10⁻³ v %.

FIG. 7 shows non-limiting, exemplary (panel a) TEM images and (panel b) the size distribution of gold nanoparticles measured by DLS.

FIG. 8 shows non-limiting, exemplary shows non-limiting, exemplary experimental data. (Panel a) Schematic of N,N-dimethylacrylamide polymerization. (Panel b) NMR spectrum (D₂O) and (Panel c) SEC chromatogram of PDMA.

FIG. 9 shows non-limiting, exemplary DSC graphs of DSC graphs of (panel a) PDMA and nanocomposites (using PDMA2) with (panel b) 0.05×10⁻³ v %, (panel c) 0.27×10⁻³ v %, (panel d) 0.53×10⁻³ v %, (panel e) 2.71×10⁻³ v %, (panel f) 5.92×10⁻³ v %, (panel g) 11.50×10⁻³ v %, and (panel h) 112.99×10⁻³ v % of nanoparticles. DSC graphs of nanocomposites (using PDMA2) with (panel i) 0 mol %, (panel j) 1 mol %, (panel k) 5 mol %, (panel l) 10 mol %, (panel m) 25 mol %, (panel n) 50 mol %, (panel o) 75 mol %, and (panel p) 100 mol % of MUA added, where the nanoparticle concentration is 0.53×10⁻³ v %. DSC graphs of nanocomposites (using PDMA1) dried at (panel q) 55° C. and (panel r) 80° C., where the nanoparticle concentration is 5.92×10⁻³ v %. DSC graphs of nanocomposites (using PDMA1) with (panel s) citrate-capped gold nanoparticles and (panel t) DDT-functionalized gold nanoparticles, where the nanoparticle concentration is 5.92×10⁻³ v %.

FIG. 10 shows non-limiting, exemplary graphs of data described herein. (Panel a) DMA graph of PDMA and nanocomposites (using PDMA2) with 0.05×10⁻³ v %, 0.27×10⁻³ v %, 0.53×10⁻³ v %, 2.71×10⁻³ v %, 5.92×10⁻³ v %, 11.50×10⁻³ v %, and 112.99×10⁻³ v % of nanoparticles. (Panel b) DMA graph of nanocomposites (using PDMA1) with citrate-capped nanoparticles and DDT-functionalized nanoparticles, where the nanoparticle concentration is 5.92×10⁻³ v %.

FIG. 11 shows a non-limiting, exemplary graph of T_{g} of polymer nanocomposites using PDMA with molecular weight distributions of 400 and 129 kg/mol.

FIG. 12 shows a non-limiting exemplary photograph of PDMA. PDMA does not self-heal at elevated temperatures.

FIG. 13 shows a non-limiting, exemplary schematic of positive cooperativity.

FIG. 14 shows non-limiting, exemplary methods of the disclosure.

FIG. 15 shows a non-limiting, exemplary schematic of polyvalent interaction.

FIG. 16 shows non-limiting, exemplary methods of the disclosure.

FIG. 17 shows a non-limiting, exemplary schematic of phase transfer and functionalization of AuNPs.

FIG. 18 shows non-limiting, exemplary data of AuNP characterization.

FIG. 19 shows non-limiting, exemplary graphs of AuNP concentration and moisture content.

FIG. 20 shows a non-limiting, exemplary photograph of self-healing behavior.

FIG. 21 shows non-limiting, exemplary data indicating reassembly of nanocomposites.

FIG. 22 shows non-limiting, exemplary NMR spectrum of MUA, hexane, and the hexane wash after functionalization of gold nanoparticles.

FIG. 23 shows non-limiting, exemplary schematic. Different ratios of interacting (MUA) and non-interacting (DDT) ligands are functionalized around nanoparticles.

FIG. 24 shows non-limiting, exemplary data of Zeta potential of gold nanoparticles with different MUA molar ratio after disassembly.

FIG. 25 shows non-limiting, exemplary DSC graphs of the nanocomposites (using PDMA with the T_{g} of 92° C. and 5 nm nanoparticles) with (panel a) 0 mol %, (panel b) 1 mol %, (panel c) 5 mol %, (panel d) 10 mol %, (panel e) 25 mol %, (panel f) 50 mol %, (panel g) 75 mol %, and (h) 100 mol % of MUA added, where the nanoparticle number is the same as 0.53×10⁻³ v % of 18 nm nanoparticles.

### DETAILED DESCRIPTION OF THE INVENTION

Detailed descriptions of one or more embodiments are provided herein. It is to be understood, however, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification can refer to “one,” but it is also consistent with “one or more,” “at least one,” and “one or more than one.”

Wherever any of the phrases “for example,” “such as,” “including” and the like are used herein, the phrase “and without limitation” is understood to follow unless explicitly stated otherwise. Similarly. “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has.” and “involves”) and the like are used interchangeably. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” can refer to a process that includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some embodiments, a straight chain or branched chain alkyl has 30 or fewer carbon atoms in its backbone (e.g., C1-C30 for straight chains, C3-C30 for branched chains), 20 or fewer, 12 or fewer, or 7 or fewer. Likewise, in some embodiments cycloalkyls have from 3-10 carbon atoms in their ring structure, e.g., have 5, 6 or 7 carbons in the ring structure. The term “alkyl” (or “lower alkyl”) as used throughout the specification, examples, and claims can include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a phosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein can refer to an alkyl group, as defined herein, but having from one to ten carbons, or from one to six carbon atoms in its backbone structure. Likewise, “lower alkenyl” and “lower alkynyl” have similar chain lengths. In some embodiments, alkyl groups are lower alkyls. In some embodiments, a substituent described herein as alkyl can be a lower alkyl.

It will be understood by those skilled in the art that the moieties substituted on the hydrocarbon chain can themselves be substituted, if appropriate. For instance, the substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF3, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, O, N, Si. P, Se, B, and S, wherein the phosphorous and sulfur atoms are optionally oxidized, and the nitrogen heteroatom is optionally quaternized. Heteroalkyls can be substituted as defined herein for alkyl groups.

The term “alkylthio” refers to an alkyl group, as defined herein, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined herein for alkyl groups.

The terms “alkenyl” and “alkynyl”, refer to unsaturated aliphatic groups analogous in length and possible substitution to the alkyls described herein, but that contain at least one double or triple bond respectively. For example,

The terms “alkoxyl” or “alkoxy” as used herein refers to an alkyl group, as defined herein, having an oxygen radical attached thereto. Representative alkoxyl groups include methoxy, ethoxy, propyloxy, and tert-butoxy. An “ether,” for example, can be two hydrocarbons covalently linked by an oxygen. Accordingly, the substituent of an alkyl that renders that alkyl an ether is or resembles an alkoxyl, such as can be represented by one of —O— alkyl, —O-alkenyl, and —O-alkynyl. Aroxy can be represented by —O-aryl or O-heteroaryl, wherein aryl and heteroaryl are as defined herein. The alkoxy and aroxy groups can be substituted as described herein for alkyl.

The terms “amine” and “amino” are art-recognized and refer to both unsubstituted and substituted amines, e.g., a moiety that can be represented by the general formula:

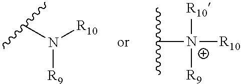

wherein R₉, R₁₀, and R_{10′} each independently represent a hydrogen, an alkyl, an alkenyl, —(CH2)ₘ— Rs or R₉ and R₁₀ taken together with the N atom to which they are attached complete a heterocycle having from 4 to 8 atoms in the ring structure; Rs represents an aryl, a cycloalkyl, a cycloalkenyl, a heterocycle or a polycycle; and m is zero or an integer in the range of 1 to 8. In some embodiments, only one of R₉ or R₁₀ can be a carbonyl, e.g., R₉, R₁₀ and the nitrogen together do not form an imide. In still other embodiments, the term “amine” does not encompass amides, e.g., wherein one of R₉ and R₁₀ represents a carbonyl. In additional embodiments, R₉ and R₁₀ (and optionally R_{10′}) each independently represent a hydrogen, an alkyl or cycloalkyl, an alkenyl or cycloalkenyl, or alkynyl. Thus, the term “alkylamine” as used herein can refer to an amine group, as defined herein, having a substituted (as described herein for alkyl) or unsubstituted alkyl attached thereto, i.e., at least one of R₉ and R₁₀ is an alkyl group.

As used herein, the term “imide” can refer to —C(O)NR′R″, wherein R′ and R″ are each independently hydrogen, or a substituted or unsubstituted alkyl, cycloalkyl, alkenyl, alkynyl, aryl aralkyl, heterocyclyl or heterocyclylalkyl group as defined herein.

As used herein, the term “halogen” can refer to —F, —Cl, —Br or —I; the term “sulfhydryl” can refer to —SH; the term “hydroxyl” can refer to —OH; and the term “sulfonyl” can refer to —SO₂—.

The term “substituted” as used herein, refers to permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, for example 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C3-C20 cyclic, heterocyclic, substituted heterocyclic, amino acid, peptide, and polypeptide groups. As used herein in reference to an “R” group, the name used to describe said “R” group can be the chemical name prior to the removal of a hydrogen. For example, wherein “R” is described as an “alkane” can refer to an “alkyl” group.

Heteroatoms such as nitrogen can have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen can have hydrogen substituents and/or any permissible substituents of organic compounds described herein which satisfy the valencies of the heteroatoms.

In various aspects, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

The term “copolymer” as used herein, can refer to a single polymeric material that is comprised of two or more different monomers. The copolymer can be of any form, such as random, block, graft, etc. The copolymers can have any end-group, including capped or acid end groups.

Before explaining at least one embodiment of the disclosure in detail, the disclosure is not necessarily limited in its application to the details set forth in the following description or exemplified by the examples. The disclosure is capable of other embodiments or of being practiced or carried out in various ways. Other compositions, compounds, methods, features, and advantages of the present disclosure will be or become apparent to one having ordinary skill in the art upon examination of the following drawings, detailed description, and examples. All such additional compositions, compounds, methods, features, and advantages can be included within this description, and be within the scope of the present disclosure.

Described herein are polymer nanocomposites, methods of producing the same, and methods of use thereof. As used herein, a “composite” refers can refer to a solid material comprising more than one phase and/or compound. The composite can be a micro-composite or a nanocomposite. As used herein, a “nanocomposite” can refer to a composite wherein the phase and/or compound domains have one or more dimensions of 100 nm or less, and/or repeat distances of 100 nm or less.

Here, we introduce the steric stabilization of nanoparticles using polymers as a strategy to synthesize polymer nanocomposites without aggregation. T_{g} increases with increasing nanoparticle concentration which results in lower T_{g}. In embodiments, the T_{g} can comprise about 40° C. to about 200° C. For example, the T_{g} can comprise less than about 40° C. about 45° C., about 50° C., about 55° C., about 60° C., about 65° C., about 70° C., about 75° C., about 80° C., about 85° C., about 90° C., about 90° C., about 100° C., about 105° C., about 110° C., about 115° C., about 120° C. about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., about 200° C., or greater than about 200 CC.

Interestingly, in some embodiments, storage moduli of polymer nanocomposites do not change within the range of nanoparticle concentrations described herein. In embodiments, the nanoparticle concentrations can comprise about 0.05×10⁻³ v % to about 99 v %, for example, the nanoparticle concentration can comprise less than about 0.05×10⁻³ v %, about 0.075×10⁻³ v %, about 0.1×10⁻³ v %, about 0.125×10⁻³ v %, about 0.15×10⁻³ v %, about 0.175×10⁻³ v %, about 0.2×10⁻³ v %, about 0.25×10⁻³ v %, about 0.275×10⁻³ v %, about 0.3×10⁻³ v %, about 0.4×10⁻³ v %, about 0.5×10⁻³ v %, about 0.6×10⁻³ v %, about 0.7×10⁻³ v %, about 0.8×10⁻³ v %, about 0.9×10⁻³ v %, about 1.0×10⁻³ v %, 0.05×10⁻² v %, about 0.075×10⁻² v %, about 0.1×10⁻² v %, about 0.125×10⁻² v %, about 0.15×10⁻² v %, about 0.175×10⁻² v %, about 0.2×10⁻² v %, about 0.25×10⁻² v %, about 0.275×10⁻² v %, about 0.3×10⁻² v %, about 0.4×10⁻² v %, about 0.5×10⁻² v %, about 0.6×10⁻² v %, about 0.7×10⁻² v %, about 0.8×10⁻² v %, about 0.9×10⁻² v %, about 1.0×10⁻² v %, about 0.05×10⁻³ v %, 0.05×10⁻¹ v %, about 0.075×10⁻¹ v %, about 0.1×10⁻¹ v %, about 0.125×10⁻¹ v %, about 0.15×10⁻¹ v %, about 0.175×10⁻¹ v %, about 0.2×10⁻¹ v %, about 0.25×10⁻¹ v %, about 0.275×10⁻¹ v %, about 0.3×10⁻¹ v %, about 0.4×10⁻¹ v %, about 0.5×10⁻¹ v %, about 0.6×10⁻¹ v %, about 0.7×10⁻¹ v %, about 0.8×10⁻¹ v %, about 0.9×10⁻¹ v %, about 1.0×10⁻¹ v %, about 0.2 v %, about 0.3 v %, about 0.4 v %, about 0.5 v %, about 0.6 v %, about 0.7 v %, about 0.8 v %, about 0.9 v %, about 1.0 v %, about 1.25 v %, about 1.5 v %, about 1.75 v %, about 2.0 v %, about 2.25 v %, about 2.5 v %, about 2.75 v %, about 3.0 v %, about 3.25 v %, about 3.5 v %, about 3.75 v %, about 4.0 v %, about 4.25 v %, about 4.5 v %, about 4.75 v %, about 5.0 v %, about 5.25 v %, about 5.5 v %, about 6.5 v %, about 7.0 v %, about 8.0 v %, about 9.0 v %, about 10.0 v %, about 15.0 v %, about 20.0 v %, about 25.0 v %, about 30.0 v %, about 35.0 v %, about 40.0 v %, about 45.0 v %, about 50.0 v %, about 55.0 v %, about 60.0 v %, about 65.0 v %, about 70.0 v %, about 75.0 v %, about 80.0 v %, about 85.0 v %, about 90.0 v %, about 95.0 v %, about 99.0 v %, or greater than about 99.0 v %.

However, without wishing to be bound by theory, above a certain nanoparticle concentration and the nature of physical interactions, we can observe an increase in storage modulus. In embodiments, the storage modulus can comprise greater than about 3.0 GPa. For example, the storage modulus can comprise less than about 1.0 GPa, about 1.0 GPa, about 1.1 GPa, about 1.2 GPa, about 1.3 GPa, about 1.4 GPa, about 1.5 GPa, about 1.6 GPa, about 1.7 GPa, about 1.8 GPa about 1.9 GPa, about 2.0 GPa, about 2.1 GPa, about 2.12 GPa, about 2.2 GPa, about 2.3 GPa, about 2.4 GPa, about 2.5 GPa, about 2.6 GPa, about 2.7 GPa, about 2.8 GPa, about 2.9 GPa, about 3.0 GPa, greater than about 3.0 GPa.

Aspects of the invention are drawn towards a dynamic polymer nanocomposite comprising: a nanoparticle; a polymer comprising a hydrogen bonding moiety sidechain; and a small molecule ligand, wherein the ligand comprises an anchoring moiety to functionalize the nanoparticle, a spacer region, and a hydrogen bonding moiety; and a polymer comprising a hydrogen bonding moiety side chain complementary to the small molecule ligand hydrogen bonding moiety.

Any nanoparticle know in the art can be used herein. In embodiments, the nanoparticle is selected from the group consisting of a gold nanoparticle (AuNP), a silver nanoparticle (AgNP), a silica nanoparticle (SiNP), a carbon nanotube, an iron oxide nanoparticle, or a micellular nanoparticle.

In embodiments, the polymer is a polyurethane or derivative thereof. For example, the polymer is a polyacrylamide or derivative thereof. For example, the polymer can be selected from the group consisting of, but is not limited to, polyacrylamide, poly(dimethylacrylamide), poly(acrylamide), poly(N-isopropylacrylamide), poly(methyl methacrylate), poly(methyl acrylate), poly(n-butyl acrylate), a polyurethane, a polyethylene terephthalate, nylon, a polycarbonate, a polyacrylate, a poly(acrylic acid), or a poly(vinyl alcohol). For example, polyacrylamide is poly(N,N′-dimethylacrylamide) (PDMA).

In embodiments, the polymer hydrogen bonding moiety side chain complementary to the small molecule ligand hydrogen bonding moiety is selected from the group consisting of —COOH, —NH₂, —OH, an amide, or a carbonyl.

As used herein, the term “anchoring moiety” can refer to a moiety that can covalently bond the small molecule ligand to the nanoparticle or nanoparticle composition. In embodiments, the small molecule ligand linker anchoring moiety is selected from the group consisting of a thiol, a silane, a carboxylic acid, a carbonyl, or an amine. For example, the small molecule ligand is a catechol-based molecule. For example, the catechol-based molecule can be any catechol-based molecule known in the art. For example, the based-molecule can be, but is not limited to, catechol, 4-nitro catechol, 4-methoxy catechol, or 3,4-dihydroxybenzoic acid.

In embodiments, small molecule hydrogen bonding moiety is selected from the group consisting of —COOH, —NH₂, —OH, an amide, or a carbonyl. For example, the small molecule ligand is a thiol fatty acid or ester. In some embodiments, the thiol fatty acid or ester is 11-mercaptoundecanoic acid or methyl 3-mercaptopropionate.

Aspects of the disclosure are drawn towards methods of synthesizing a dynamic polymer nanocomposite, the method comprising: (a) dispersing at least one nanoparticle (NP) in an aqueous solution, thereby producing a NP dispersion; (b) adding a polymer comprising a hydrogen bonding moiety sidechain into the NP dispersion thereby producing a polymer-NP mixture; (c) removing the aqueous solution from the polymer-NP mixture; (d) introducing an organic solvent into the polymer-NP mixture; and (e) adding a small molecule ligand (MUA) into the polymer-NP, wherein the small molecule ligand comprises an anchoring moiety to functionalize the NP, a spacer region, and a hydrogen bonding moiety complementary to the polymer binding moiety, thereby assembling to form a dynamic polymer nanocomposite.

In embodiments, the the polymer is selected from the group consisting of a polyacrylamide, a polyurethane, a polyethylene terephthalate, nylon, a polycarbonate, a polyacrylate, a poly(acrylic acid), or a poly(vinyl alcohol). For example, the polyacrylamide is poly(N,N′-dimethylacrylamide) (PDMA).

In embodiments, the anchoring moiety is selected from the group consisting of a thiol group, a silanol group, a carboxylic acid group, a carbonyl group, or an amine group.

As used herein, the term “spacer region” can refer to any part of the small molecule linker that is not the anchoring moiety or the hydrogen bonding moiety. The method of claim 11, wherein the spacer region is selected from the group consisting of an alkyl chain, an ethylene glycol, or a poly(ethylene glycol).

In embodiments, the organic solvent can comprise any polar or nonpolar solvent known in the art. For example, the solvent can comprise chloroform, water, ether, ethyl acetate, ethanol, isopropanol, acetonitrile, DMF, or any combination thereof. For example, the organic solvent can be chloroform.

As used herein, the term “nanoparticle” can refer to a particle with at least one dimension less than about 5 micrometers. In embodiments, the nanoparticle comprises a gold nanoparticle (AuNP), a silver nanoparticle (AgNP), a silica nanoparticle (SiNP), a carbon nanotube, an iron oxide nanoparticle, or a micellular nanoparticle.

Further methods of the disclosure comprise tuning the polymer nanocomposite glass transition temperature (T_{g}) by increasing the nanoparticle concentration in step (a) and the MUA concentration in step (e), thereby increasing the interfacial binding interactions and increasing the T_{g}. In embodiments, methods of the disclosure comprising tuning the polymer nanocomposite stress-relaxation rate by increasing the nanoparticle concentration in step (a) and the MUA concentration in step (e), thereby increasing the interfacial binding interactions and increasing the relaxation rate.

Aspects of the invention are drawn towards polymer nanocomposite produced by the methods described herein.

In embodiments, the nanocomposites described herein can be used in diverse applications. For example, the applications can include, but are not limited to additive manufacturing, energy storage, sacrificial parts for the semiconductor industry, gas separation membranes, soft robotics, actuators, self-healing polymers, and coatings. Further the disassembly and separation of polymer matrix and nanoparticles can provide for a sustainable pathway for designing hybrid, mixed materials and extending the end-of-life fate of common materials.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

Mechanically Robust, Self-Healing Polymer Nanocomposites with Tailorable Nanoparticle-Based Bonds

### Abstract

A trade-off between self-healing kinetics and mechanical robustness has been one of the major challenges in intrinsically self-healing polymers. Here, we introduce the concept of “Nanoparticle-Based Bonds” as noncovalent polymer crosslinks where the nanoparticles are functionalized with carboxylic acid-containing small molecule ligands that form complementary H-bonds with amides on poly(N,N-dimethylacrylamide). Through self-assembly, self-healing nanocomposites are synthesized with significantly improved T_{g} up to 124° C. (33° C. higher than that of polymer matrix), fast relaxation rate, and stiffness (ranging from 1.7 to 2.6 GPa), which are unprecedentedly high for self-healing polymers reported thus far. The effects of nanoparticle concentration, % moisture content, and surface ligand densities are systematically varied to control macroscopic properties, including T_{g}, stiffness, stress-relaxation rate, and self-healing behavior. These materials can undergo a reversible assembly process in excess water. This provides a unique opportunity to position this material not only for sustainability but also as sacrificial parts during manufacturing processes.

### Introduction

Noncovalent polymer networks represent an attractive alternative to covalently crosslinked networks (i.e., thermosets) as these materials can self-heal through the recovery of dynamic bonds.¹⁻⁴ It prolongs the lifetime of materials against physical damage and provides a more sustainable path for a lower carbon cycle and life cycle cost. The assembly of noncovalent networks is driven by reversible bonds within these materials that can rebuild after physical damage.⁵⁻⁷ Nonetheless, their usage is limited by low glass transition temperatures (T_{g}) and reduced mechanical properties.^{5, 8-10} Self-healing materials based on dynamic covalent chemistries such as Diels-Alder cycloaddition,^{11, 12} dynamic sulfur-based chemistries,^{13, 14} boronic ester metathesis,¹⁵⁻¹⁷ and imine exchange¹⁸ exhibit a crosslinked network structure like thermosetting and elastomeric materials,¹⁹⁻²¹ Because dynamic properties (e.g., self-healing) are only activated under relatively harsh conditions for dynamic covalent networks, faster physical aging is inevitable,^{18, 22-24} Compared with dynamic covalent networks, noncovalent networks can effectively self-heal via reversible bond exchanges under mild conditions. Despite the increase in research on the topic of self-healing polymers, a trade-off between mechanical robustness (i.e., stiffness and T_{g}) and self-healing rate remains a challenge.²⁵

Using bio-inspired design strategies, multivalent noncovalent interactions have been introduced to design polymer networks with an enhanced association constant of weak bonds via positive cooperativity. Meijer and coworkers introduced the ureido-pyrimidinone to obtain networks.^{26,27} Cooperative binding behaviors have also been observed for other supramolecular networks such as Ca²⁺-induced gelation of ionic polysaccharides (also referred to as extended egg-box structures) and iron-catechol coordinated networks.^{28, 29} These networks possess mechanical properties competitive with conventional thermosets but can be reprocessed to yield materials with the recovered mechanical integrity. These systems have been demonstrated for gels, which are soft with Young's moduli of ˜10³-10⁴ Pa. Cooperative binding interactions can also be introduced by assembling nanoparticles and polymers with attractive interactions at the interface. The assemblies of most polymer nanocomposites with inorganic nanoparticles thus far are driven by either physical adsorption of polymers or covalently grafting polymers onto nanoparticle surfaces.³¹⁻³⁴ Holten-Andersen and coworkers demonstrated that incorporating Fe₂O₃ nanoparticles into a catechol-modified polymer network leads to reversible metal-coordination bonds at the interface, which results in slower stress relaxation and improved storage modulus.³¹ The formation of multivalent, interfacial interactions between polymers and nanoparticles can provide a multifold improvement in stiffness, however, these networks exhibit much slower stress-relaxation rate and self-healing kinetics.^{31, 32, 35}

The impact of tunable interfacial interactions (e.g., the number of binding events) on bulk properties (e.g., stiffness) independent of nanoparticle concentration and size has remained unexplored. According to the Guth-Gold model, the nanoparticle concentration and size simultaneously influence the material's stiffness.³⁶ Therefore, decouple the number of interfacial binding, nanoparticle concentration, and nanoparticle size to better understand the role of cooperative interfacial interactions. Nonetheless, the number of interfacial bindings cannot be altered without varying nanoparticle size and concentration using the conventional assembly strategies for polymer nanocomposites.

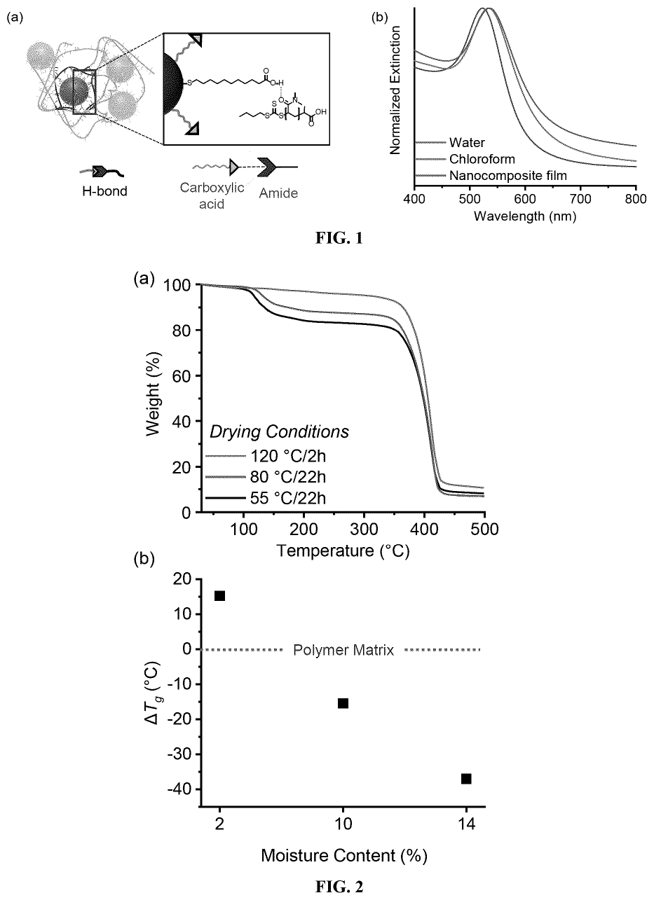

This work introduces the concept of dynamic nanoparticle-based bonds with tailorable interfacial binding events, which are surface-functionalized nanoparticles that serve as multivalent crosslinks to drive the assembly of polymers into a noncovalent network (FIG. 1 panel a). Complementary H-bonding interactions at the interface between polymers and nanoparticles (e.g., H-bond donor and acceptor) are introduced such that these building blocks preferentially interact with each other. The effects of different variables such as nanoparticle concentration, ligand density around nanoparticles, and moisture content on T_{g}, storage modulus, stress-relaxation rate, and self-healing behavior are investigated using differential scanning calorimetry (DSC), thermogravimetric analysis (TGA), and dynamic mechanical analysis (DMA). In embodiments, gold nanoparticles can be used because they are facile to synthesize with precise control over size and have distinct localized surface plasmon resonance, enabling colorimetric monitoring of nanoparticle aggregation in solution and solid-state using UV-vis spectroscopy. With proper chemistries to attach ligands onto nanoparticle surfaces, the polymer nanocomposite system described herein can be expanded to different nanoparticle compositions, and it can broaden the type of heterogeneous materials that can be synthesized for advanced functions, such as plasmonic or catalytically active nanocomposites.

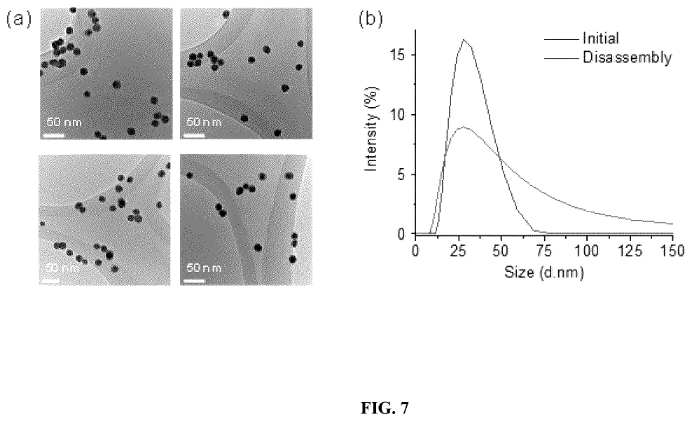

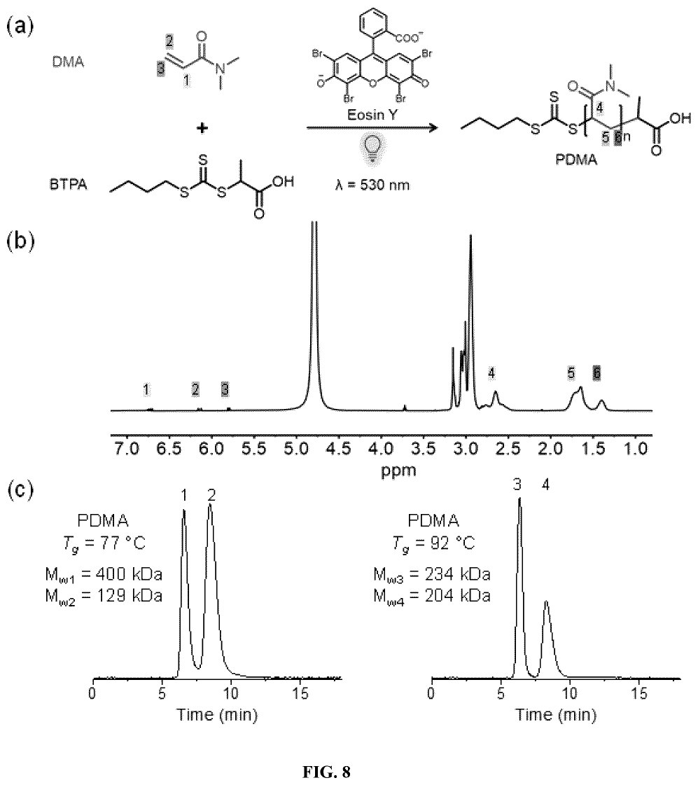

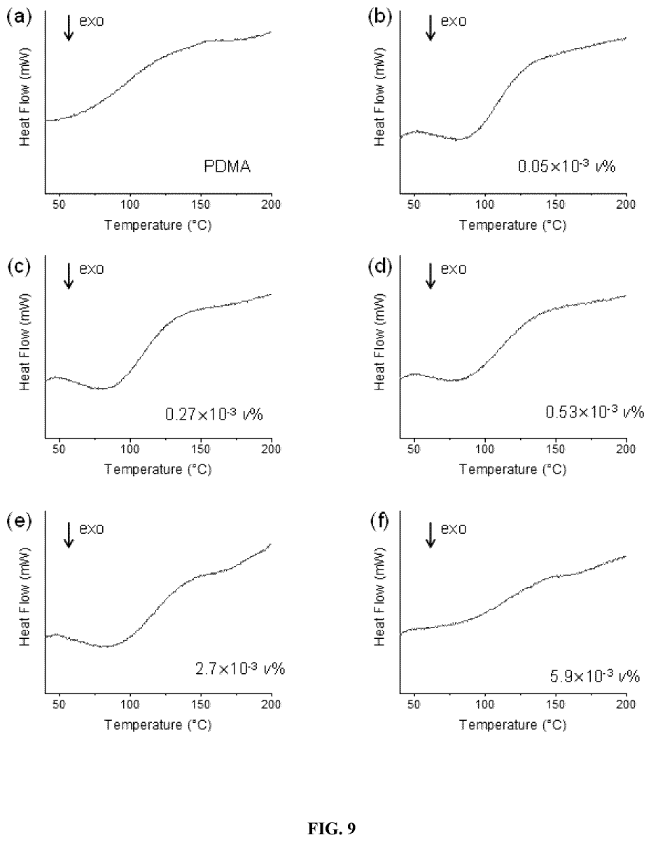

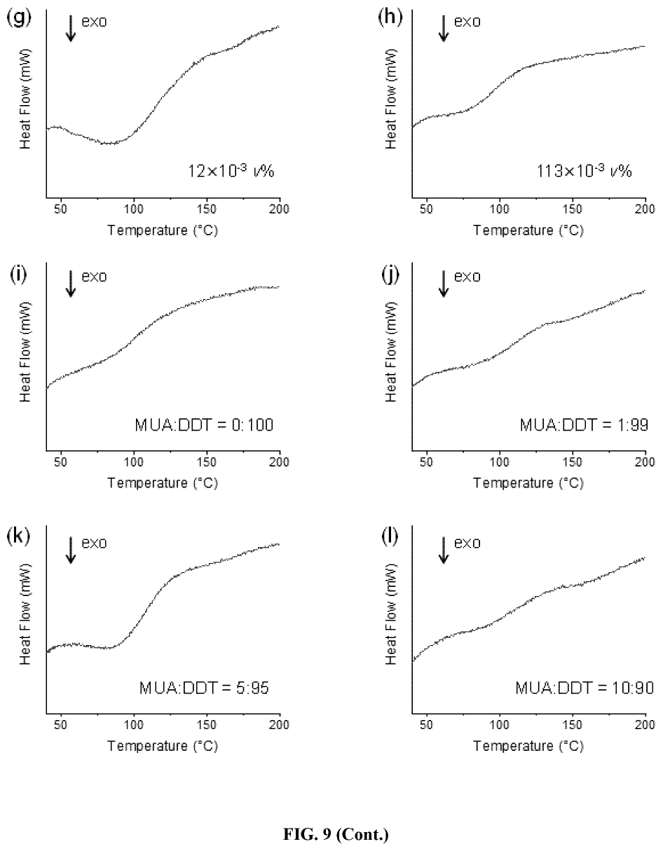

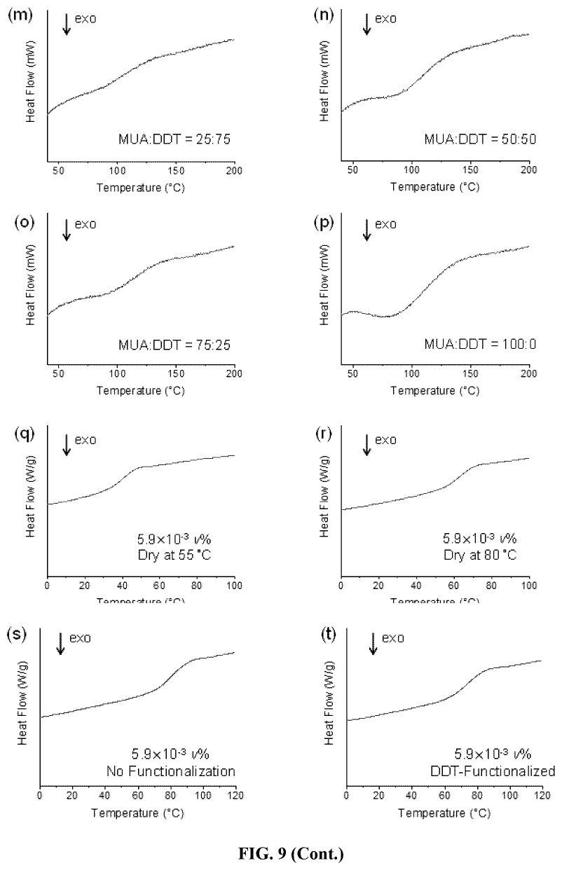

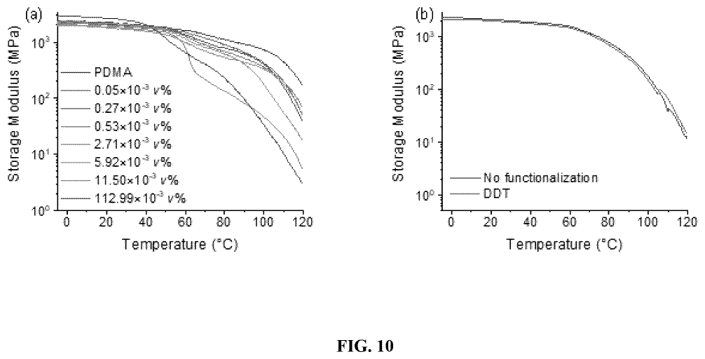

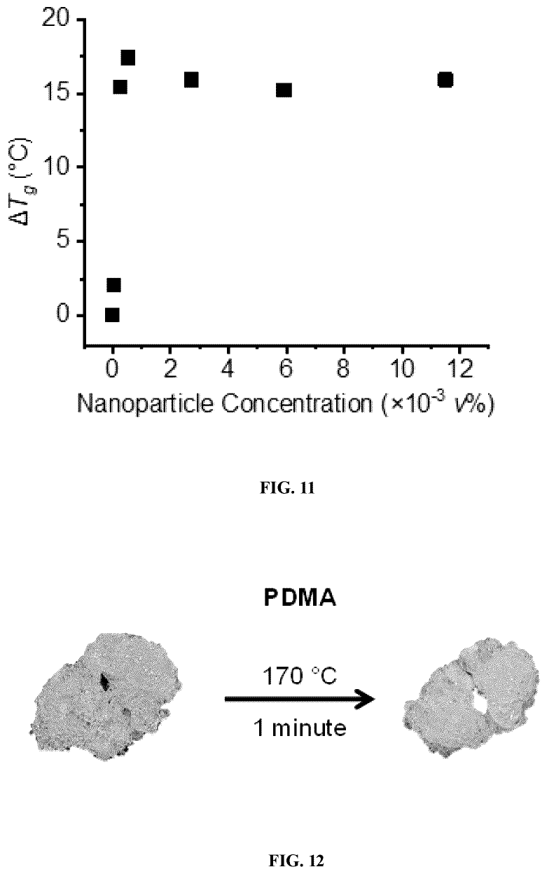

A stepwise approach is developed to assemble a polymer nanocomposite. First, citrate-capped nanoparticles dispersed in water are synthesized using the Turkevich method,^{37, 38} The nanoparticles with a diameter of 18.3±1.7 nm are characterized using UV-vis spectroscopy transmission electron microscopy (TEM) (FIG. 7 panel A), and dynamic light scattering (DLS) (FIG. 7 panel b). Photoinduced electron/energy transfer-reversible addition-fragmentation chain-transfer polymerization (FIG. 8 panel a) is used to synthesize poly(N,N-dimethylacrylamide) (PDMA) with two different distributions of molecular weights (FIG. 11). Two sets of PDMAs with different molecular distributions exhibit T₃ of 77° C. and 91° C., respectively, which is attributed to the molecular weight distribution (i.e., one containing a higher fraction of lower molecular weight polymers exhibits a lower T_{g}). ¹H-NMR spectroscopy (FIG. 8 panel b) and size exclusion chromatography (FIG. 8 panel c) are used for the characterization. To assemble a polymer nanocomposite, nanoparticles need to be redispersed in a solvent, in which 11-mercaptoundecanoic acid (MUA) (i.e., surface ligand) is soluble and nanoparticles do not aggregate. No assembly is observed in the presence of excess water because water-polymer and water-nanoparticle interactions are extremely favorable, and they instead remain dispersed after mixing. However, solvent exchange of citrate-capped nanoparticles into an organic solvent results in instant aggregation. To prevent nanoparticle aggregation in an organic solvent, polymers are added to the nanoparticle solution before solvent exchange, where the weak adsorption of polymers onto nanoparticle surfaces sterically stabilizes nanoparticles from aggregation.^{39,40} The stability of nanoparticles can be monitored as nanoparticle aggregation in a composite can leads to failure in material properties.³³ Different concentrations of nanoparticles are added relative to the amount of polymer. The nanoparticles are functionalized with MUA through favorable gold-thiol bond formation. Surface functionalization is performed for two hours in chloroform, which is removed and dried at an elevated temperature (e.g., 55, 80, and 120° C.). The unreacted ligands are removed by washing with hexane. The assembly of a polymer nanocomposite is driven by complementary hydrogen bonding interactions at the interface between PDMA (i.e., hydrogen bond acceptor) and carboxylic acids (i.e., hydrogen bond donor) of MUA functionalized on gold nanoparticles (FIG. 1 panel a).

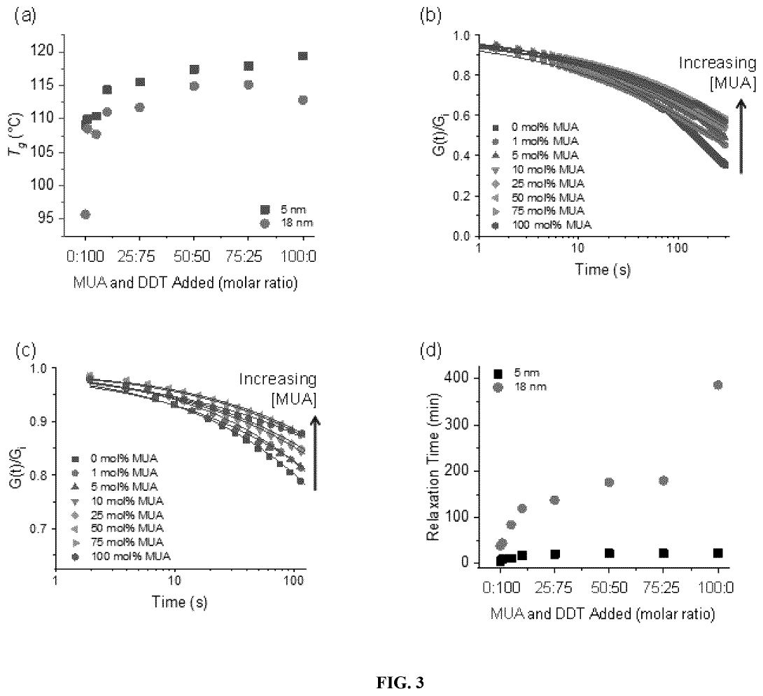

Due to the favorable interactions between water and PDMA, polymer segments become more mobile in the presence of higher moisture content, resulting in faster segmental dynamics and lower T_{g}. The amount of moisture can be controlled by tuning the drying temperature of polymer nanocomposites. The polymer nanocomposites for moisture study consist of 5.92×10⁻³ v % of MUA-functionalized nanoparticles and PDMA with T_{g} of 77° C. Three different drying temperatures are chosen to test this effect: the temperatures below the T_{g} (55° C.), close to the T_{g} (80° C.), and above the T_{g} of the PDMA (120° C.). TGA shows that the sample dried at 120° C. has the lowest moisture content of 2 wt %, whereas drying at 55 and 80° C. led to polymer nanocomposites with moisture contents of 14 and 10 wt %, respectively. The moisture contents are extrapolated from the weight loss around 100° C., which is the boiling temperature of water (FIG. 2 panel a). In the presence of 2 wt % of moisture, the nanocomposite exhibits the highest T_{g} of 95° C., which is 15° C. higher than that of PDMA. With additional H-bonding interactions introduced via the incorporation of surface-functionalized nanoparticles, the segmental mobility is reduced, and thus the T_{g}, which is the temperature at which polymer transitions from glassy to rubbery state, increases. With an increasing amount of moisture, the T decreases to 40° C., which is 37° C. lower than that of PDMA (FIG. 2 panel b). These results indicate that water plays a role as a plasticizer, speeds up the segmental relaxation process of the polymer, and lowers the T_{g}.^{41, 42} Without wishing to be bound by theory, water interferes with the maximal interactions between polymers and nanoparticles, lowering the T_{g}. The following polymer nanocomposites shown in this work use the PDMA with T_{g} of 91° C. and are dried at 120° C. to decouple the effect of water on the composite properties.

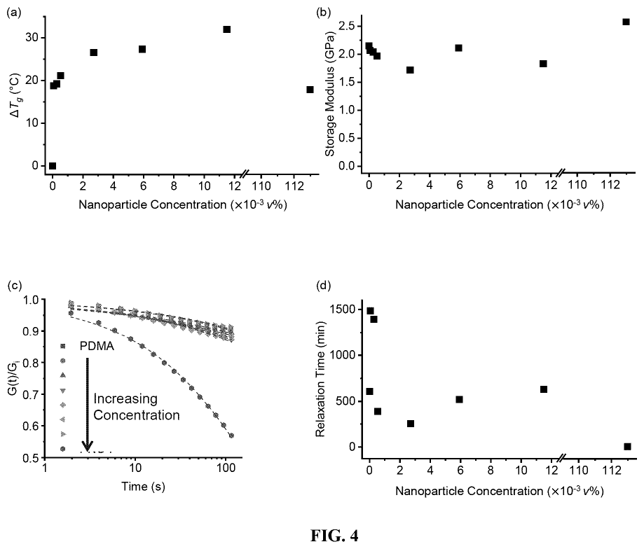

To understand how tuning the number of complementary interfacial interactions affects the mechanical properties, such as T_{g} and stress-relaxation rate, the surface density of MUA was varied by co-functionalizing nanoparticles with a mixture of MUA and 1-dodecanethiol (DDT) at constant nanoparticle concentration of 0.53×10⁻³ v %. It is important to add DDT as sacrificial ligands while changing the density of MUAs functionalized around nanoparticles as the low surface ligand density of nanoparticles can significantly destabilize during processing, leading to aggregation.⁴³⁻⁴⁴ A mixture of DDT and MUA with varying molar ratios ranging from 0 to 100 mol % was used to alter the ligand density around nanoparticles (FIG. 3 panel a). The zeta potential of gold nanoparticles with 100 mol % of MUA after disassembly has the lowest zeta potential, indicating the successful functionalization with different MUA molar ratios (FIG. 24). Described herein the alkane thiols of DDT and MUA can have similar binding affinity. The contributions of interfacial H-bond interactions with polymers will stem from MUA as DDT lacks carboxylic acids (FIG. 22). The T_{g} increases with increasing amount of MUA coating the nanoparticle surfaces in both 5 nm and 18 nm nanoparticles (FIG. 3 panel a). The nanocomposite with 18 nm nanoparticles reaches its maximum T_{g} of 115° C. at 75 mol % of MUA, which is 20° C. higher than the T_{g} of the polymer nanocomposite containing 100 mol % of DDT-functionalized nanoparticles (0 mol % MUA). For the nanocomposite with 5 nm nanoparticles, the T_{g} reaches its maximum of 119° C. at 100 mol % of MUA. The T_{g} of nanocomposites with 5 nm nanoparticles is higher than those of nanocomposites with 18 nm nanoparticles. The difference in nanoparticle size results in different diffusivity and free volume. According to previous studies, smaller nanoparticles have higher diffusivity and lower free volume, resulting in higher T_{g}.⁴⁵⁻⁴⁶ At 100 mol % of MUA, an estimated thiol density of 5.7 sulfur/nm² is used for calculation based on previous literature.⁴⁷ Because the nanoparticle concentration remains the same across all samples, we attribute the increase in T_{g} to the increasing number of interfacial interactions. For the nanocomposites using 18 nm nanoparticles, the T_{g} is 113° C., which is slightly lower than the maximum value. A steep increase in T_{g} of 13° C. is observed at relatively low concentrations of MUA from 0 to 1 mol % whereas a more gradual increase is observed at higher concentrations of MUA. Without wishing to be bound by theory, with 18 nm nanoparticles with approximately 4,900 thiolated ligands per nanoparticle, the available H-bonds within a volume relative to polymers reach the maximum at a relatively low MUA concentration.

The rearrangement time of dynamic bonds characterized by the relaxation time is a parameter for the self-healing rate.⁴⁸ The healing time can significantly affect the performance of self-healing polymers, and a fast-healing material that restores functionality is ideal to minimize service interruption. The characteristic stress-relaxation time is calculated from Kohlrausch's stretched-exponential relaxation model, which is shown below:

$${G}_{t} = {G}_{i} exp [ - {( t / τ )}^{a} ] , 0 < a < 1$$

where Gᵢ is the plateau modulus, r is the characteristic stress-relaxation time, and a is a fitting parameter. The stress-relaxation time increases with increasing MUA ratio (FIG. 3 panels b-d). A shorter relaxation time indicates higher segmental mobility and faster dynamic exchange of nanoparticle-based bonds in the network.⁴⁹⁻⁵⁰ Here, the nanoparticle concentrations are consistent among all the samples. Therefore, the segmental mobility from the polymer remains the same. The dynamic bond exchange rate has a crucial effect on stress-relaxation time. Without wishing to be bound by theory, the bond exchange rate is slower with increasing H-bonding sites due to the positive cooperativity. The bond stability is enhanced through positive cooperativity arising from the increasing ligand density, which leads to the decrease of the dissociation constant and a slower bond exchange rate.⁵¹ The nanocomposites using 5 nm nanoparticles have faster stress-relaxation time because of the higher diffusivity and less interfacial H-bonding interactions.⁴⁶

The effect of nanoparticle concentration was explored by measuring the T_{g}, storage modulus, and characteristic stress-relaxation time. The PDMA used for mechanical studies has molecular weight distributions of 234 and 204 kg/mol (FIG. 8 panel c). The T_{g} increases with increasing nanoparticle concentration where the maximum T_{g} of 124° C., which is ˜33° C. higher than that of the PDMA, is reached at 0.11 v % of nanoparticles (FIG. 4 panel a). There are several factors that influence the T_{g} of heterogeneous materials, such as free volume, segmental mobility of polymers, and the number of interfacial interactions.⁵²⁻⁵⁵ Adding gold nanoparticles reduces the segmental mobility and increases the number of interfacial interactions, which results in an increase of T_{g} at a range of nanoparticle concentrations from 0.05×10⁻³ v % to 11.5×10⁻³ v %. However, there is a slight decrease in the T_{g} at the highest nanoparticle concentration tested in this work (FIG. 4 panel a). An increase in particle-particle interactions reduces the particle-polymer interactions, which limits the ability of nanoparticles to reduce segmental mobility. Similar trend in T_{g} is observed in the nanocomposites using PDMA with molecular weight distributions of 400 and 129 kg/mol. The storage modulus can be observed across different concentrations of nanoparticles (FIG. 4 panel b). The storage moduli range from 1.7 to 2.6 GPa when the nanoparticle concentration is varied between 0.05×10⁻³ v % to 113×10⁻³ v %. With a relatively low range of concentrations of gold nanoparticles used (maximum concentration of 113×10⁻³ v %) compared to other mechanically reinforced composites, without wishing to be bound by theory, high stiffness stems from the intrinsic mechanical property of the polymer matrix (G′ of PDMA measured: 2.2 GPa). This is different from other studies on polymer nanocomposites where mechanical reinforcement of lower stiffness polymers is achieved by adding rigid fillers. Similar storage modulus values observed in our system at a range of nanoparticle concentrations further support our findings that adding nanoparticles does not contribute much to material stiffness.

Importantly, control experiments using 5.92×10⁻³ v % nanoparticles without complementary H-bonding moieties further indicate that interfacial H-bonds lead to an increase in T_{g} with increasing concentrations of nanoparticles. To show that the presence of interfacial H-bonds leads to the change in thermomechanical property, as-synthesize, citrate-capped gold nanoparticles and gold nanoparticles functionalized with 1-dodecanethiol (DDT, a thiolated alkyl chain without the carboxylic-acid end moiety) are introduced. These nanoparticles are not able to form complementary H-bonds with PDMA. Slight changes in T_{g} of +4 and −3° C. are observed for citrate-capped and dodecanethiol-functionalized nanoparticles, respectively, whereas the system with the same concentration of MUA-functionalized nanoparticles exhibited an increase in T_{g} of 28° C. (Table 1, FIG. 4 panel a). These results indicate that the increase in T_{g} upon adding MUA-functionalized nanoparticles is due to the complementary interfacial interactions.

| | | | Storage |
|---|---|---|---|
| | | T_{g} | Modulus |
| Sample | Surface Ligand | (° C.) | (GPa) |
| PDMA | N/A | 77 | 1.8 |
| Polymer | No functionalization | 81 | 2.0 |
| Nanocomposite | | | |
| Polymer | 1-dodecanethiol | 74 | 1.9 |
| Nanocomposite | | | |

Table 1 shows the T_{g} and storage modulus of PDMA, polymer nanocomposite with unfunctionalized gold nanoparticles, and polymer nanocomposite with 1-dodecanethiol-functionalized gold nanoparticles. The nanoparticle concentration is 5.92 × 10⁻³ ν %.

Stress-relaxation time decreases with increasing nanoparticle concentration (FIG. 4 panel d). Shorter relaxation time indicates fast segmental mobility and dynamic exchange of nanoparticle-based bonds in the network. With higher nanoparticle concentration, free volume effect is more important, which results in faster segmental mobility. However, the H-bond exchange rate is slower with more H-bonding sites. Without wishing to be bound by theory, polymer mobility has more impact on the stress-relaxation time. Therefore, the decrease in stress-relaxation time is mainly due to the higher polymer mobility arising from the free volume effect.

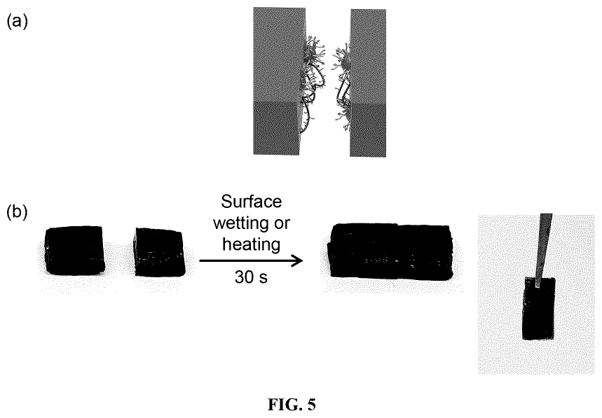

These materials are rigid materials with storage moduli in the range of 10⁹ Pa similar to thermosets, which is unprecedently high compared with traditional self-healing polymers. Thermosets are normally not responsive to most solvents and not processable once formed, yet these materials with nanoparticle-based bonds are processable under specific triggers such as heat and water. The PDMA, which is used as the polymer matrix, has no self-healing ability (FIG. 12). Adding MUA-functionalized nanoparticles allows these materials to self-heal the fractured interface under mild conditions. Heating slightly above the T_{g} (119° C.) leads to self-healing in 30 min by facilitating the segmental dynamics and bond rearrangement time (FIG. 5 panel b). Under ambient conditions, polymer nanocomposites are not able to heal after a reasonable time period. The strength of H-bond between carboxylic acid and amide is considered a weak association energy (less than RT In (N) where N is the number of segments between complementary H-bonds) and without wishing to be bound by theory can result in faster bond breakage and formation.⁵⁶ There are many variables, such as the bond strength and subsequent bond-rearrangement time, the waiting time between the sample damage and self-healing, and the roughness of the damaged surface, that can simultaneously affect the rate bond rearrangement and self-healing.⁴⁹ Without wishing to be bound by theory, minimal healing at room temperature is caused by two reasons; i) the positive cooperative effect of H-bonds mediated by nanoparticles increases the bond strength, reaching a new equilibrium state quickly, and ii) slow segmental mobility of the PDMA increases the time of diffusion to find the open carboxylic acid moiety around nanoparticles. Hydration (a few μL of water) of the surface speeds up the self-healing process at room temperature to 30 s, can be due to breaking of the occupied H-bonds between nanoparticles and polymers as these building blocks interact favorably with water and accelerating segmental mobility (FIG. 3 panel b). This is consistent with the effect of moisture on the T_{g} shown in FIG. 2. This observation opens interesting opportunities for applications that prefer self-healable polymers with low healing temperatures where hydration facilitates self-healing at room temperature, and the mechanical properties (close to the interface where water is applied) are recovered upon drying.

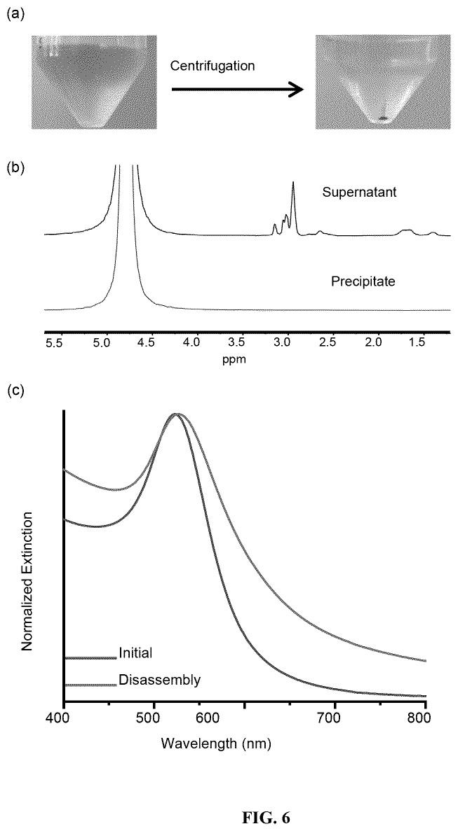

From the sustainability point of view, without wishing to be bound by theory, we can recycle the polymer and nanoparticle-based bonds, and we can repurpose the materials after the end-of-life cycle. The work described herein indicates that polymer nanocomposites can be disassembled by immersing in excess water and each building block can be purified by centrifugation due to density differences. First, the polymer nanocomposite is immersed in excess water (mL), where the solution slowly turns red without agitation due to the dispersion of gold nanoparticles (FIG. 6 panel a). Centrifuging this solution results in a clear supernatant and dark red precipitate on the bottom of the tube. ¹H NMR and UV-vis spectroscopy are used to characterize the components in the supernatant and precipitate (FIG. 6 panel a). The supernatant and the precipitate redispersed in deuterium oxide are measured using NMR, which shows that PDMA is present in the supernatant (FIG. 6 panel b). The sharp resonance peak in the UV-vis spectra of the solution containing the precipitate (gold nanoparticles) indicates that nanoparticles are well-dispersed after the separation process. A shift in surface plasmon peak from 523 to 527 nm relative to the spectra of citrate-capped gold nanoparticles is due to the change in refractive index from surface-functionalization with MUA (FIG. 6 panel c).

### Conclusion

By applying the concept of positive cooperativity induced by multivalent interactions, we developed an approach to assemble a dynamic polymer nanocomposite using surface-functionalized nanoparticles and polymers with improved T_{g} and self-healing ability different from that of PDMA. Nanoparticle aggregation is a serious problem that influences the final properties of polymer nanocomposites. Here, we introduce the steric stabilization of nanoparticles using polymers as a strategy to synthesize polymer nanocomposites without aggregation. T_{g} increases with increasing nanoparticle concentration which results in lower T_{g}. Interestingly, storage moduli of polymer nanocomposites do not change drastically within the range of nanoparticle concentrations described herein. However, without wishing to be bound by theory, above a certain nanoparticle concentration and the nature of physical interactions, we can observe an increase in storage modulus. Intrinsically self-healing polymers have can be used in diverse applications, ranging from additive manufacturing, energy storage, sacrificial parts for the semiconductor industry, gas separation membranes, and coating. Finally, the disassembly and separation of polymer matrix and nanoparticles can provide for a sustainable pathway for designing hybrid, mixed materials and extending the end-of-life fate of common materials.

### REFERENCES

1. Cong, H.-P.; Wang, P.; Yu, S.-H., Stretchable and Self-Healing Graphene Oxide-Polymer Composite Hydrogels: A Dual-Network Design. Chemistry of Materials 2013, 25 (16), 3357-3362.
2. Li, C. H.; Wang, C.; Keplinger, C.; Zuo, J. L.; Jin, L.; Sun, Y.; Zheng, P.; Cao. Y.; Lissel, F.; Linder, C.; You, X. Z.; Bao, Z., A highly stretchable autonomous self-healing elastomer. Nat Chem 2016, 8 (6), 618-24.
3. Mei, J. F.; Jia, X. Y.; Lai, J. C.; Sun, Y.; Li, C. H.; Wu, J. H.; Cao, Y.; You, X. Z.; Bao, Z., A Highly Stretchable and Autonomous Self-Healing Polymer Based on Combination of Pt . . . Pt and pi-pi Interactions. Macromol Rapid Commun 2016, 37 (20), 1667-1675.
4. Wang, Q.; Mynar, J. L.; Yoshida, M.; Lee, E.; Lee, M.; Okuro, K.; Kinbara, K.; Aida, T., High-water-content mouldable hydrogels by mixing clay and a dendritic molecular binder. Nature 2010, 463 (7279), 339-43.
5. Wang, S.; Urban, M. W., Self-healing polymers. Nature Reviews Materials 2020, 5 (8), 562-583.
6. Wei, Z.; Yang, J. H.; Zhou, J.; Xu, F.; Zrinyi, M.; Dussault, P. H.; Osada, Y.; Chen, Y. M., Self-healing gels based on constitutional dynamic chemistry and their potential applications. Chem Soc Rev 2014, 43 (23), 8114-31.
7. Hager, M. D.; Greil, P.; Leyens, C.; van der Zwaag, S.; Schubert, U. S., Self-healing materials. Adv Mater 2010, 22 (47), 5424-30.
8. Feng, X.; Li, G., Room-Temperature Self-Healable and Mechanically Robust Thermoset Polymers for Healing Delamination and Recycling Carbon Fibers. ACS Appl Mater Interfaces 2021, 13 (44), 53099-53110.
9. Niu, Q.; Han, H.; Liu, X.; Li, B.; Li, H.; Li, Z., A rapid self-healing glassy polymer/metal-organic-framework hybrid membrane at room temperature. Dalton Trans 2023, 52 (10), 3148-3157.
10. Xu, J.; Chen, J.; Zhang, Y.; Liu, T.; Fu, J., A Fast Room-Temperature Self-Healing Glassy Polyurethane. Angew Chem Int Ed Engl 2021, 60 (14), 7947-7955.
11. Liu, Y.-L.; Chuo, T.-W., Self-healing polymers based on thermally reversible Diels-Alder chemistry. Polymer Chemistry 2013, 4 (7).
12. Ratwani, C. R.: Kamali, A. R.; Abdelkader, A. M., Self-healing by Diels-Alder cycloaddition in advanced functional polymers: A review. Progress in Materials Science 2023, 131.
13. Lai, Y.; Kuang, X.; Zhu, P.; Huang, M.; Dong, X.; Wang, D., Colorless, Transparent, Robust, and Fast Scratch-Self-Healing Elastomers via a Phase-Locked Dynamic Bonds Design. Adv Mater 2018, 30 (38), e1802556.
14. Azcune, I.; Odriozola, I., Aromatic disulfide crosslinks in polymer systems: Self-healing, reprocessability, recyclability and more. European Polymer Journal 2016, 84, 147-160.
15. Robinson, L. L.; Self, J. L.; Fusi, A. D.; Bates, M. W.; Read de Alaniz, J.; Hawker, C. J.; Bates, C. M.; Sample, C. S., Chemical and Mechanical Tunability of 3D-Printed Dynamic Covalent Networks Based on Boronate Esters. ACS Macro Lett 2021, 10 (7), 857-863.
16. Gosecki, M.; Gosecka, M., Boronic Acid Esters and Anhydrates as Dynamic Cross-Links in Vitrimers. Polymers (Basel) 2022, 14 (4).
17. Yang, Y.; Du, F.-S.; Li, Z.-C., Thermally healable and reprocessable polymethacrylate networks based on diol-mediated metathesis of 6-membered boronic esters. Polymer Chemistry 2020, 11 (11). 1860-1870.
18. Deng, G.; Tang, C.; Li, F.; Jiang, H.; Chen, Y., Covalent Cross-Linked Polymer Gels with Reversible Sol-Gel Transition and Self-Healing Properties. Macromolecules 2010, 43 (3), 1191-1194.
19. Fortman, D. J.; Brutman. J. P.; De Hoe, G. X.; Snyder, R. L.; Dichtel, W. R.; Hillmyer, M. A., Approaches to Sustainable and Continually Recyclable Cross-Linked Polymers. ACS Sustainable Chemistry & Engineering 2018, 6 (9), 11145-11159.
20. Chakma, P.; Konkolewicz, D., Dynamic Covalent Bonds in Polymeric Materials. Angew Chem Int Ed Engl 2019, 58 (29), 9682-9695.
21. Scheutz, G. M.; Lessard, J. J.; Sims, M. B.; Sumerlin, B. S., Adaptable Crosslinks in Polymeric Materials: Resolving the Intersection of Thermoplastics and Thermosets. J Am Chem Soc 2019, 141 (41), 16181-16196.
22. Kim, H.; Yarin, A. L.; Lee, M. W., Self-healing corrosion protection film for marine environment. Composites Part B: Engineering 2020, 182.
23. Huang, Y., Paul. D. R., Effect of temperature on physical aging of thin glassy polymer films. Macromolecules 2005, 38 (24), 10148-10154.
24. Zaghdoudi, M.; Kommling, A.; Jaunich, M.; Wolff, D., Scission, Cross-Linking, and Physical Relaxation during Thermal Degradation of Elastomers. Polymers (Basel) 2019, 11 (8).
25. Li, B.; Cao, P. F.; Saito, T.; Sokolov, A. P., Intrinsically Self-Healing Polymers: From Mechanistic Insight to Current Challenges. Chem Rev 2023, 123 (2), 701-735.
26. Folmer, B. J. B.; Sijbesma, R. P.; Versteegen, R. M.; van der Rijt, J. A. J.; Meijer, E. W., Supramolecular Polymer Materials: Chain Extension of Telechelic Polymers Using a Reactive Hydrogen-Bonding Synthon. Advanced Materials 2000, 12 (12), 874-878.
27. Sijbesma, R. P., Beijer, F. H., Brunsveld, L., Folmer, B. J. B., Hirschberg, J. H. K. K., Lange, R. F. M., Lowe, J. K. L., Meijer, E. W., Reversible Polymers Formed from Self-Complementary Monomers Using Quadruple Hydrogen Bonding. Science 1997, 278 (5343), 1601-1604.
28. Braccini, I., Perez, S., Molecular Basis of Ca2+-Induced Gelation in Alginates and Pectins: The Egg-Box Model Revisited. Biomacromolecules 2001, 2 (4). 1089-1096.
29. Filippidi, E., Cristiani, T. R., Eisenbach, C. D., Waite, J. H., Israelachvili. J. N., Ahn. B. K., Valentine, M. T., Toughening Elastomers Using Musselinspired Iron-Catechol Complexes. Science 2017, 358 (6362), 502-505
30. Gu, Y.; Zhao, J.; Johnson, J. A., Polymer Networks: From Plastics and Gels to Porous Frameworks. Angew Chem Int Ed Engl 2020, 59 (13), 5022-5049.
31. Li, Q.; Barrett, D. G.; Messersinith, P. B.; Holten-Andersen, N., Controlling Hydrogel Mechanics via Bio-Inspired Polymer-Nanoparticle Bond Dynamics. ACS Nano 2016, 10 (1), 1317-24.
32. Song. J.; Li, Q.; Chen. P.; Keshavarz, B.; Chapman, B. S.; Tracy, J. B.; McKinley, G. H.; Holten-Andersen, N., Dynamics of dual-junction-functionality associative polymer networks with ion and nanoparticle metal-coordinate cross-link junctions. Journal of Rheology 2022, 66 (6). 1333-1345.
33. Neikirk, C. C.; Chung, J. W.; Priestley, R. D., Thermomechanical behavior of hydrogen-bond based supramolecular poly(ε-caprolactone)-silica nanocomposites. RSC Advances 2013, 3 (37).
34. Gu, Y.; Alt, E. A.; Wang, H.; Li, X.; Willard, A. P.; Johnson, J. A., Photoswitching topology in polymer networks with metal-organic cages as crosslinks. Nature 2018, 560 (7716), 65-69.
35. Priestley. R. D., Ellison, C. J., Broadbelt, L. J., Torkelson, J. M., Structural Relaxation of Polymer Glasses at Surfaces, Interfaces, and In Between. Science 2005, 309 (5733), 456-459.
36. Guth, E., Theory of Filler Reinforcement. Journal of Applied Physics 1945, 16 (1), 20-25.
37. Bastus, N. G.; Comenge, J.; Puntes, V., Kinetically controlled seeded growth synthesis of citrate-stabilized gold nanoparticles of up to 200 nm: size focusing versus Ostwald ripening. Langmuir 2011, 27 (17), 11098-105.
38. Wuithschick, M.; Birnbaum, A.; Witte, s.; Sztucki, M.; Vainio, U.; Pinna, N.; Rademann, K.; Emmerling, F.; Kraehnert, R.; Polte, J., Turkevich in New Robes: Key Questions Answered for the Most Common Gold Nanoparticle Synthesis. ACS Nano 2015, 9 (7), 7052-7071.
39. Hotze, E. M.; Phenrat, T.; Lowry, G. V., Nanoparticle aggregation: challenges to understanding transport and reactivity in the environment. J Environ Qual 2010, 39 (6), 1909-24.
40. Kim, S.; Oh, S. M.; Kim, S. Y.; Park, J. D., Role of Adsorbed Polymers on Nanoparticle Dispersion in Drying Polymer Nanocomposite Films. Polymers (Basel) 2021, 13 (17).
41. Matveeva, Y. I.; Grinberga, V. Y.; Tolstoguzov, V. B., The plasticizing effect of water on proteins, polysaccharides and their mixtures. Glassy state of biopolymers, food and seeds. Food Hydrocolloids 2000, 14 (5), 425.
42. Thomas Karbowiak, H. H., Liliane Leger, Dominique Champion, Frédéric Debeaufort, and Andrée Voilley, Effect of Plasticizers (Water and Glycerol) on the Diffusion of a Small Molecule in Iota-Carrageenan Biopolymer Films for Edible Coating Application. Biomacromolecules 2006, 7 (6), 2011.
43. Shishan Zhang, G. L., La-ongnuan Srisombat, and T. Randall Lee, Rationally Designed Ligands that Inhibit the Aggregation of Large Gold Nanoparticles in Solution. Journal of the American Chemical Society 2008, 130 (1), 113-120.
44. Mei, B. C.; Oh, E.; Susumu, K.; Farrell, D.; Mountziaris, T. J.; Mattoussi, H., Effects of ligand coordination number and surface curvature on the stability of gold nanoparticles in aqueous solutions. Langmuir 2009, 25 (18), 10604-11.
45. Grabowski, C. A.; Mukhopadhyay, A., Size Effect of Nanoparticle Diffusion in a Polymer Melt. Macromolecules 2014, 47 (20), 7238-7242.
46. Khan, R. A. A.; Qi, H. K.; Huang, J. H.; Luo. M. B., A simulation study on the effect of nanoparticle size on the glass transition temperature of polymer nanocomposites. Soi Matter 2021, 17 (35), 8095-8104.
47. Hinterwirth, H.; Kappel, S.; Waitz, T.; Prohaska, T.; Lindner, W.; Lämmerhofer, M., Quantifying Thiol Ligand Density of Self-Assembled Monolayers on Gold Nanoparticles by Inductively Coupled Plasma-Mass Spectrometry. ACS Nano 2013, 7 (2), 1129-1136.
48. Yan, T.; Schroter, K.; Herbst, F.; Binder, W. H.; Thurn-Albrecht, T., Unveiling the molecular mechanism of self-healing in a telechelic, supramolecular polymer network. Sci Rep 2016, 6, 32356.
49. Luo, J.; Demchuk, Z.; Zhao, X.; Saito, T.; Tian, M.; Sokolov, A. P.; Cao, P.-F., Elastic vitrimers: Beyond thermoplastic and thermoset elastomers. Matter 2022, 5 (5), 1391-1422.
50. Yamawake, K.; Hayashi, M., The role of tertiary amines as internal catalysts for disulfide exchange in covalent adaptable networks. Polymer Chemistry 2023, 14 (6), 680-686.
51. Mammen, M.; Choi, S.-K.; Whitesides, G. M., Polyvalent Interactions in Biological Systems: Implications for Design and Use of Multivalent Ligands and Inhibitors. Angewandte Chemie International Edition 1998, 37 (20), 2754-2794.
52. Ahn, J.; Chung, W.-J.; Pinnau, I.; Guiver, M. D., Polysulfone/silica nanoparticle mixed-matrix membranes for gas separation. Journal of Membrane Science 2008, 314 (1-2), 123-133.
53. T. C. Merkel; B. D. Freeman; R. J. Spontak; Z. He; I. Pinnau; P. Meakin: Hill, A. J., Sorption, Transport, and Structural Evidence for Enhanced Free Volume in Poly(4-methyl-2-pentyne)/Fumed Silica Nanocomposite Membranes. Chem Mater 2003, 15 (1), 109-123.
54. Lizundia, E.; Serna, I.; Axpe, E.; Vilas, J. L., Free-volume effects on the thermomechanical performance of epoxy-SiO₂ nanocomposites. Journal of Applied Polymer Science 2017, 134 (34).
55. Demir, B.; Chan, K.-Y.; Yang, D.; Mouritz, A.; Lin, H.; Jia, B.; Lau, K.-T.; Walsh, T. R., Epoxy-gold nanoparticle nanocomposites with enhanced thermo-mechanical properties: An integrated modelling and experimental study. Composites Science and Technology 2019, 174, 106-116.
56. Stukalin, E. B.: Cai, L. H.; Kumar, N. A.; Leibler, L.; Rubinstein, M., Self-Healing of Unentangled Polymer Networks with Reversible Bonds. Macromolecules 2013, 46 (18).

### Materials

Eosin Y disodium salt (EY, Sigma-Aldrich, >85%), triethanolamine (TEtOHA, Sigma-Aldrich, 99%), chloroform (Sigma-Aldrich, 99.8%), gold (III) chloride trihydrate (HAuCl₄·3H₂O, Sigma-Aldrich, 99.9%), sodium citrate tribasic dihydrate, II-mercaptoundecanoic acid (MUA, Fisher Scientific, 97%), 1-dodecanethiol (DDT, Fisher Scientific, 98%), and n-hexane (≥95%, Sigma Aldrich), deuterium chloroform (Sigma-Aldrich), and deuterium oxide (Sigma-Aldrich) are used as received. VN-dimethylacrylamide (Sigma-Aldrich, 99%) is filtered through activated basic aluminum oxide column (Brockmann I. Sigma Aldrich) before use to remove inhibitor. BTPA is synthesized by the method reported in the literature.¹ Milli-Q water is used as solvent for aqueous solution unless otherwise noted.

### Synthesis of Gold Nanoparticles

Gold nanoparticles are synthesized by inverse Turkevich method.² 1.375 mL of 60 mM sodium citrate tribasic dihydrate aqueous solution and 36.125 mL of water is added to a vial and is heated to 60° C. After 15 minutes of vigorous stirring at 60° C., 0.25 mL of 25 mM HAuCl₄·3H₂O aqueous solution is added. The reaction proceeds overnight until the color changes from clear to red. UV-vis spectrophotometer (Cary 3500 Multicell) and transmission electron microscope (TEM, Philips CM200) are used for characterization. For TEM sample preparation, 10 μL of gold nanoparticles aqueous solution as synthesized is added on the grid (Lacey Formvar/Carbon, 200 mesh, Copper approximate grid hole size is 97 μm) with micropipette, dry for 5 mins, and repeat for three times. Philips CM200 is used at 200 kV.

### Synthesis of Poly(N,N-Dimethylacrylamide)

Poly(N,N-dimethylacrylamide) (PDMA) is synthesized by photoinduced electron transfer-reversible addition-fragmentation chain-transfer polymerization (FIG. 8 panel a). N,N-dimethylacrylamide is the monomer, 2-(n-butyltrithiocarbonate)-propionic acid (BTPA) is the chain transfer agent, and eosin Y (EY) is the photoinitiator.³ After removing the monomer inhibitor by basic alumina, 2.576 mL of DMA is added to a vial, followed by addition of 0.992 mL of 12.6 mM BTPA solution in ethanol, 0.288 mL of 0.434 mM of EY solution in ethanol, and 4.969 mL of ethanol. The vial is placed under green light and is quenched after 16 hours of reaction, resulting in 85% of conversion from nuclear magnetic resonance spectroscopy (NMR, Bruker 500 MHz), and the molecular weight is 211 kg/mol obtained by size exclusion chromatography.

### Size Exclusion Chromatography (SEC)

Tosoh HLC-8420 GPC system and LenS₃ multi-angle light scattering detector are used. Milli-Q water is the mobile phase, TSKgel Super H-RC (6.0 mm ID×150 mm, 15 μm) is the reference column, and TSKgel GMPW_{XL} (7.8 mm ID×300 mm, 13 μm) is the sample column. Data is acquired by EcoSEC Elite and SECView software. Sample is run at the flow rate of 1.0 mL/min and the temperature of the system is 40° C.

### Solvent Exchange of Gold Nanoparticles

37.75 mL of gold nanoparticle aqueous solution as synthesized is centrifuged using Eppendorf Centrifuge 5804 at 5000 rcf for 20 min and 27.75 mL of supernatant is removed after centrifugation, resulting in a concentrated gold nanoparticle solution of 11.75 nM. 137.3 μL of concentrated gold nanoparticles, 10.86 mL of water, and 6.006 g of PDMA are added to a conical tube and vortex until completely dissolved, resulting in a master solution for different studies. More gold nanoparticle solution is added according to the molar ratio between nanoparticles and polymer chains. Subsequently, all solutions are dried at 55° C. under vacuum overnight, resulting in thin films in the bottom of conical tubes.

### Functionalization of Gold Nanoparticles and Assembly of Nanocomposites

Gold nanoparticles are functionalized with MUA assuming the surface coverage is 5.70 sulfur/nm².⁴ Twenty times excess amount is added to ensure the complete functionalization of AuNPs. For the nanocomposite where the nanoparticle concentration is 0.53×10⁴ v %, 38.41 μL of 4.58 mM MUA in chloroform solution is added. The solution is then incubated at 35° C. for 2 hours. The unreacted MUA is removed by washing with hexane. Different molar ratios between MUA and DDT are added accordingly without adding excess amount. Nanocomposites are made after evaporating chloroform at 55° C. under vacuum overnight and 120° C. for another 2 hours.

### Disassembly of Nanocomposites

0.1 g of polymer nanocomposites are dissolved in 1 mL of water, followed by centrifugation at 7500 rcf for 1 hour, resulting in a clear supernatant and dark red precipitate. The supernatant is removed, and the precipitate is redispersed in 1 mL of water. NMR is measured using deuterium chloroform (for the supernatant) and deuterium oxide (for the precipitate). Zeta potential and size distribution of disassembled gold nanoparticles are measured as is.

### Self-Healing Efficiency Test

A piece of DMA strip is used for the self-healing efficiency test. The strip is cut into half and self-heal with the addition of water. The sample self-healed in 2 minutes, followed by drying in vacuum oven at 120° C. DMA test is used for measuring recovered storage modulus.

### Thermogravimetric Analysis (TGA)

TGA 5500 from TA instruments is used to measure the composition in the nanocomposite and TRIOS software is used for data acquisition and analysis. The platinum HT pan is tared in the TGA before running any sample. Subsequently, 5 mg of sample is loaded on the pan and the experiment starts. Temperature ramp is set at 10° C./min starting from room temperature to 500° C.

### Differential Scanning Calorimetry (DSC)

DSC 2500 from TA instruments is used to measure the glass transition temperature (T_{g}) (for moisture content study) and TRIOS software is used for data acquisition and analysis. 5 mg of sample is loaded into Tzero pans and Tzero hermetic lids, which are bought from TA instruments. Temperature ramp is set at 10° C./min and three heating and cooling cycles are done from −20° C. to 120° C.

LABSYS EVO from Setaram is used to measure the T_{g} of the samples other than moisture content study. 15 mg of sample is loaded into the crucible and the experiment is carried out with one heating process from 30° C. to 200° C.

### Dynamic Mechanical Analysis (DMA)

DMA 850 from TA instruments is used to characterize mechanical properties of nanocomposites, including modulus and stress-relaxation time. Nanocomposites are melt-pressed at 100° C. and under pressure of 15,000 pounds with 0.127 mm spacers to form thin films. The resulting films are cut into rectangular shapes with a length of 2 cm and width of 0.5 cm. Storage modulus test is carried out with 0.01% strain and the temperature ramping from −5° C. to 150° C. or until the sample fractures. The soak time at start temperature is 300 s and the ramp rate is 3° C./min. The modulus shown in the report is at 25° C. Stress-relaxation experiments are carried out with constant 1% strain and temperatures are set at 35° C. for 2 min.

### Dynamic Light Scattering (DLS)

Zetasizer Pro from Malvern is used to characterize the size distribution of gold nanoparticles and the zeta potential of the charges on the surface of nanoparticles. The citrate-capped gold nanoparticles are measured as synthesized. The zeta potential and size distribution after disassembly are measured after adjusting the precipitate solution to pH=11 by adding 0.2 M sodium hydroxide solution.

### REFERENCES

1. Ferguson, C. J., Hughes, R. J., Nguyen, D., Pham, B. T. T., Gilbert, R. G., Serelis, A. K., Such, C. H., Hawkett, B. S., Ab Initio Emulsion Polymerization by RAFT-Controlled Self-Assembly. Macromolecules 2005, 38, 2191-2204.
2. Bastus, N. G.; Comenge, J.; Puntes, V., Kinetically controlled seeded growth synthesis of citrate-stabilized gold nanoparticles of up to 200 nm: size focusing versus Ostwald ripening. Langmuir 2011, 27 (17), 11098-105.
3. Zaquen, N.; Kadir, A. M. N. B. P. H. A.; Iasa, A.; Corrigan, N.; Junkers, T.; Zetterlund, P. B.; Boyer, C., Rapid Oxygen Tolerant Aqueous RAFT Photopolymerization in Continuous Flow Reactors. Macromolecules 2019, 52 (4), 1609-1619.
4. Hinterwirth, H.; Kappel, S.; Waitz, T.; Prohaska, T.; Lindner, W.; Lämmerhofer, M., Quantifying Thiol Ligand Density of Self-Assembled Monolayers on Gold Nanoparticles by Inductively Coupled Plasma-Mass Spectrometry. ACS Nano 2013, 7 (2), 1129-1136.

### Example 2

### Dynamic Supramolecular Bonds in Self-Healing Polymer Nanocomposites

### Abstract

A new synthesis of dynamic polymer nanocomposites with enhanced mechanical properties is described herein where polymer networks are crosslinked via supramolecular bonds at the interface of nanoparticles and polymer matrix. Herein, gold nanoparticles (AuNPs) are functionalized with 11-mercaptoundecanoic acids which form hydrogen bonds with poly(dimethylacrylamide) (PDMA) and assemble to form a polymer network upon mixing. As a result, these surface-functionalized nanoparticles are called “particle-based crosslinks.” Without wishing to be bound by theory, multiple hydrogen bonds at the nanoparticle-polymer interface promote cooperative binding behavior, resulting in much stronger bonds than those with monovalent interactions. PDMA and AuNPs are synthesized via photoinduced electron transfer-reversible addition fragmentation chain-transfer polymerization and inverse Turkevich method, respectively. We described herein that steric stabilization of nanoparticles as a consequence of weak polymer adsorption can prevent nanoparticle aggregation during solvent exchange and can lead to successful surface functionalization. In contrast to the inherent properties of polymer matrix, self-assembled polymer nanocomposite exhibits a glass transition temperature of 90° C. and self-healing properties at a range of temperatures due to interfacial hydrogen bonds.

Without wishing to be bound by theory, physical nanoparticle-polymer interactions are individually weak, but with multivalency and cooperative binding, the overall bond strength will enhance.

### Non-Limiting, Exemplary Methods

PDMA Polymerization
Inverse Turkevich Method
Phase Transfer and Functionalization of AuNPs

### Non-Limiting, Exemplary Results

### AuNP Characterization

The synthesis at 60° C. results in larger AuNPs with a narrower size distribution than that synthesized at 100° C.
AuNPs are transferred to chloroform and dimethyl sulfoxide without aggregation due to the steric stabilization from polymer adsorption.
The size of AuNPs can be determined by UV-Vis spectra. An absorbance peak at 523 mu indicates the nanoparticle diameter of approx. 18.5 nm.

### Glass Transition Temperature of Nanocomposites

Moisture content can be varied by tuning the drying temperature after functionalization and is measured using thermogravimetric analysis.
Particle-polymer interactions increase the glass transition temperature because the backbone requires more energy for segmental motion.
Without H-bonding between nanoparticles and polymers, the glass transition temperature is similar to that of pure PDMA.

### Self-Healing Behavior

Nanocomposites self-heal with addition of water or at elevated temperature.
Water frees up the occupied (unavailable) hydrogen bonds due to favorable interaction.
After drying, new particle-polymer bonds are formed.

### Reassembly of Nanocomposites

No AuNPs aggregate after disassembly and reassembly.

### Non-Limiting, Exemplary Findings

Phase transfer of AuNPs can be achieved by the steric effects from polymer adsorption.
Functionalized AuNPs act as crosslinkers within polymer matrix, increasing the glass transition temperature with better mechanical properties.
Mechanical tests (e.g. modulus and stress-relaxation) will be performed.
This work can be extended to different particles (e.g. silica), different particle size and shape, different ligand density and length, and different supramolecular interactions to tune nanocomposite properties.

### Example 4

### Non-Limiting, Exemplary Protocols

Experiments described herein used citrate-capped gold nanoparticles dispersed in water as our starting material. In principle, any nanoparticles (e.g., gold, silver, silica, micellar, etc.) dispersed in an aqueous solution can be incorporated into the final composite material. Polymer matrix (e.g., poly(N, N-dimethyl acrylamide)) is synthesized using a controlled radical polymerization of acrylic monomers (e.g., reversible addition-fragmentation chain-transfer polymerization). Free radical polymerizations can also be used with this class of acrylic monomers if the control over molecular weight, dispersity, and architecture is not an important consideration. Nanoparticles are functionalized using 11-mercaptoundecanoic acid (MUA) that can form H-bonds with polymer side chains. Because the selected small molecule ligand (MUA) is not soluble in water, solvent exchange is performed to solubilize surface ligands for functionalization. Because nanoparticles in water are not stable in organic solvent (i.e., solvent exchange leads to aggregation), polymers are first added to sterically stabilize nanoparticles in water, followed by removal of water and solvent exchange to chloroform. Transferring nanoparticles to organic solvent in the presence of polymers can keep nanoparticles stable in organic solvent. The stability and dispersion of nanoparticles at each processing step are characterized using UV-Vis spectroscopy. The ligands are then added to this solution and the solution is incubated at 35° C. for 2 hours for efficient functionalization. To realize a solid-state sample, the solvent is removed at 55° C. under vacuum overnight, followed by drying at an elevated temperature (120° C.) for 2 hours. Unreacted ligands, which can act as plasticizers if remaining in the final sample, are removed by washing with hexane, which is a solvent that dissolves MUA but not polymers and surface-functionalized nanoparticles.

Several variables such as nanoparticle concentration and size, surface ligand density, average polymer chain lengths, and water content are systematically investigated. The surface ligand density is an important design parameter to control the number of interfacial binding interactions. The surface coverage of MUA around 18 nm gold nanoparticles is assumed to be 5.70 sulfur/nm² from literature. The surface ligand density of the H-bond forming MUA is controlled via the alteration of functionalization methods. During the functionalization step, different molar ratios of MUA and non-H-bond forming 1-dodecanethiol (DDT) as sacrificial ligands are added. Similar to the standard protocol, unreacted MUA and DDT are removed by washing with hexane. The glass transition temperature and relaxation rates of bulk material increase with the increasing number of interfacial interactions per nano-junction (at the nanoparticle concentration of 0.53×10⁻³ v %). Increasing the nanoparticle concentration (i.e., the number of interfacial interactions and nanoparticles) leads to an increase in the glass transition temperature and faster or similar relaxation rate (variable with nanoparticle concentration). The stiffness of all samples (storage modulus) remains in a GPa range between 1.7 and 2.6 GPa. While the matrix is not self-healing, introducing the H-bonds by adding surface-functionalized nanoparticles imparts self-healing behavior in the final composite.

As described herein, the small molecule ligands described herein can have an anchoring moiety compatible with the type of nanoparticle used as known in the art. For example, the ligand can comprise a thiol anchoring moiety for functionalization of a gold nanoparticle. For example, the ligand can comprise a silanol anchoring moiety for functionalization of a silica nanoparticle.

### Example 5

Mechanically Robust, Self-Healing Polymer Nanocomposites with Tailorable Nanoparticle-Based Bonds

### Abstract

A trade-off between self-healing kinetics and mechanical strength has been one of the major challenges in intrinsically self-healing polymers. These materials are not suitable for high-performance applications due to low glass transition temperatures (T_{g}) and weak mechanical properties. Here, we introduce the concept of “Nanoparticle-Based Bonds” as noncovalent polymer crosslinks through the assembly of surface-functionalized nanoparticles and polymers to design self-healing materials with significantly improved T_{g} above 110° C. and stiffness (in a GPa range) compared to those of conventional self-healing polymers. The dynamic properties including self-healing and fast stress-relaxation rate stem from complementary hydrogen bonding interactions at the interface between carboxylic acid-functionalized nanoparticles and amides on poly(N,N-dimethylacrylamide). A range of nanoparticle concentrations, moisture content, and surface ligand densities on nanoparticles is systematically studied to understand their effects on bulk properties, including stiffness, stress-relaxation rate, and self-healing behavior. These materials can undergo reversible assembly and disassembly using water as the stimuli and have the potential to not only increase the sustainability of polymeric materials but also serve as sacrificial materials during manufacturing processes.

### Background

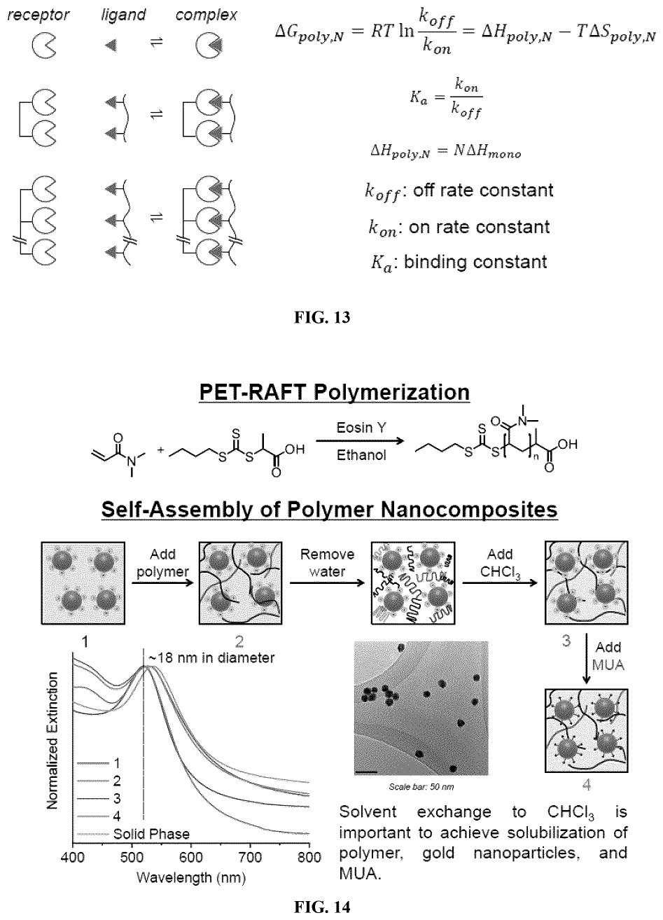

Self-Healing with Dynamic Bonds
Positive Cooperativity (FIG. 13)
Polyvalent Interactions (FIG. 1 panel a)

The self-assembly of surface-functionalized nanoparticles and conventionally non-dynamic polymers (that exhibit high Tg and stiffness) via complementary H-bonding interactions will lead to self-healing behavior.

### Non-Limiting, Exemplary Methods (FIG. 14)

### Results/Discussions

### The Effect of Moisture on Tg (FIG. 2)

Moisture content can be varied by tuning the drying temperature
Nanocomposites are dried at 120° C. to minimize the plasticizing effect.
   Ligand Density Study (FIG. 3 panels a and b)
MUA and DDT are added simultaneously to prevent aggregation during preparation.
Tg increases 15° C. from 0 mol % of MUA to 1 mol % of MUA due to the complementary H-bonding interactions.

### Results and Discussion

### Nanoparticle Concentration Study (FIG. 4)

### Self-Healing Behavior (FIG. 5)

Water frees up the occupied H-bonds due to the favorable interaction.
In the absence of moisture of heat as external trigger, no noticeable self-healing is observed at room temperature.

### Disassembly of Nanocomposites (FIG. 6)

### Conclusions

Phase transfer of gold nanoparticles is achieved by the steric stabilization from polymer adsorption.
Functionalized gold nanoparticles act as crosslinkers within the polymer matrix, increasing the glass transition temperature.
Self-healing is introduced complementary interactions between functionalized nanoparticles and polymers.
Water and heat can expedite self-healing process.
This work can be extended to different particle compositions (e.g., silica), size, shape, and ligand design to further tune nanocomposite properties.

### Example 6

### Dynamic Supramolecular Bonds in Self-Healing Polymer Nanocomposites

### Abstract

A new synthesis of dynamic polymer nanocomposites with enhanced mechanical properties is reported where polymer networks are crosslinked via supramolecular bonds at the interface of nanoparticles and polymer matrix. In this work, gold nanoparticles (AuNPs) are functionalized with 11-mercaptoundecanoic acids which form hydrogen bonds with poly(dimethylacetamide) (PDMA) and assemble to form a polymer network upon mixing. As a result, these surface-functionalized nanoparticles are called “particle-based crosslinks.” The multiple hydrogen bonds at the nanoparticle-polymer interface can promote cooperative binding behavior, resulting in much stronger bonds than those with monovalent interactions. PDMA and AuNPs are synthesized via photoinduced electron transfer-reversible addition fragmentation chain-transfer polymerization and inverse Turkevich method, respectively. We demonstrate that steric stabilization of nanoparticles as a consequence of weak polymer adsorption prevents nanoparticle aggregation during solvent exchange and leads to successful surface functionalization. In contrast to the inherent properties of polymer matrix, self-assembled polymer nanocomposite exhibits a glass transition temperature of 90° C. and self-healing properties at a range of temperatures due to interfacial hydrogen bonds.

### Background

Without wishing to be bound by theory: Physical nanoparticle-polymer interactions are individually weak, but with multivalency and cooperative binding, the overall bond strength will enhance.

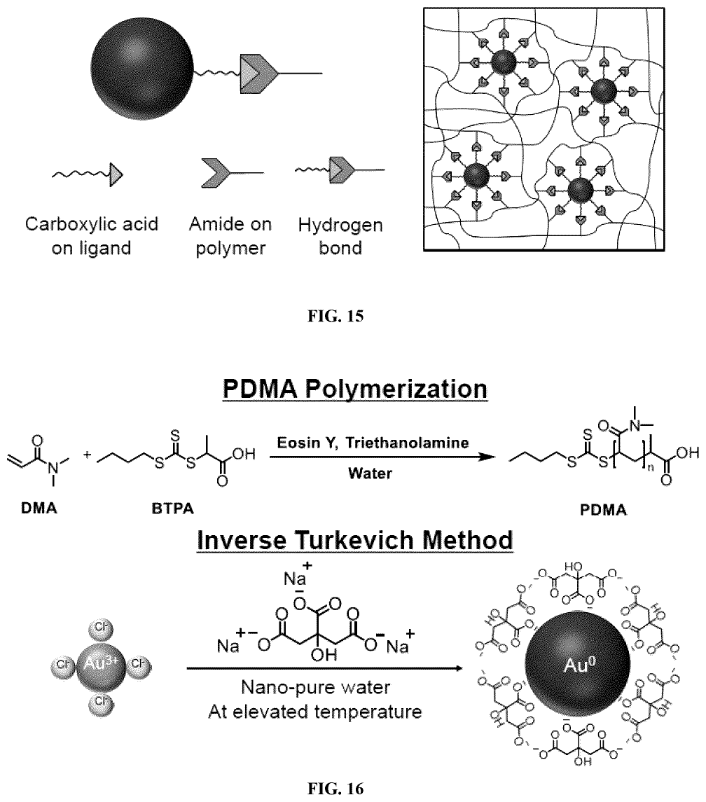

### Polyvalent Interaction (FIG. 15)

Non-Limiting, Exemplary Methods (FIG. 16)

### PDMA Polymerization

Inverse Turkevich Method

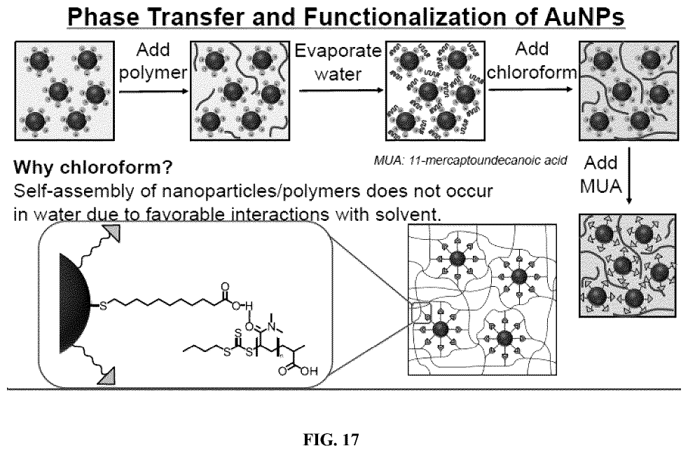

### Phase Transfer and Functionalization of AuNPs (FIG. 17)

### Results and Discussion

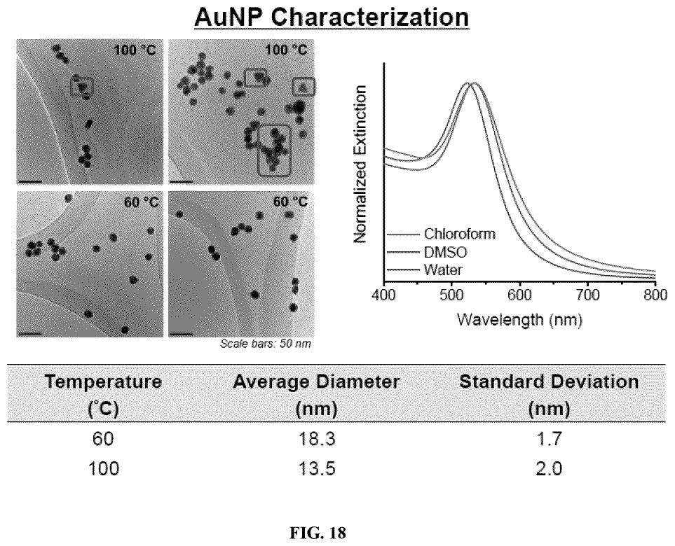

AuNP Characterization (FIG. 18)

The synthesis at 60° C. results in larger AuNPs with a narrower size distribution than that synthesized at 100° C.

AuNPs are transferred to chloroform and dimethyl sulfoxide without aggregation due to the steric stabilization from polymer adsorption.

The size of AuNPs can be determined by UV-Vis spectra. An absorbance peak at 523 nm indicates the nanoparticle diameter of approx. 18.5 nm.

### Results and Discussion

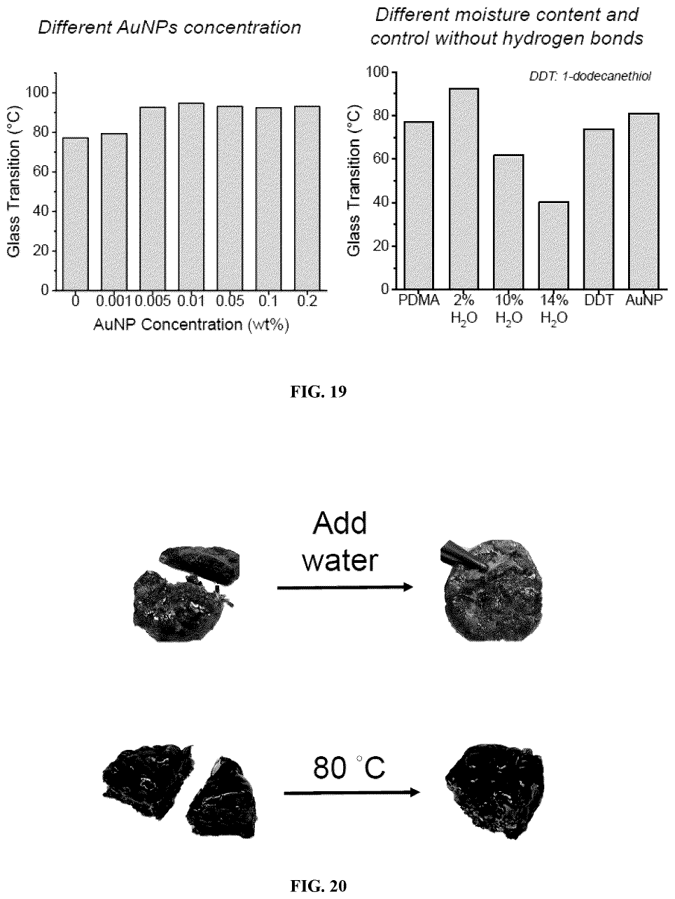

Glass Transition Temperature of Nanocomposites (FIG. 19)

Moisture content can be varied by tuning the drying temperature after functionalization and is measured using thremogravimetry analysis.

Particle-polymer interactions increase the glass transition temperature because the backbone requires more energy for segmental motion.

Without H-bonding between nanoparticles and polymers, the glass transition temperature is similar to that of pure PDMA.

### Self-Healing Behavior (FIG. 20)

Nanocomposites self-heal with addition of water or at elevated temperature.

Water frees up the occupied (unavailable) hydrogen bonds due to favorable interaction.

After drying, new particle-polymer bonds are formed.

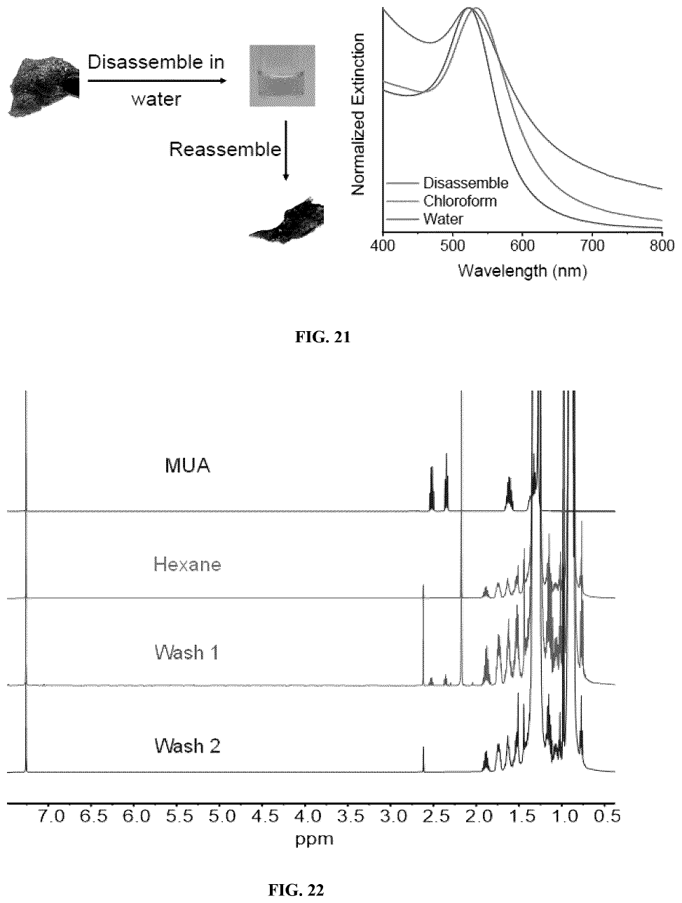

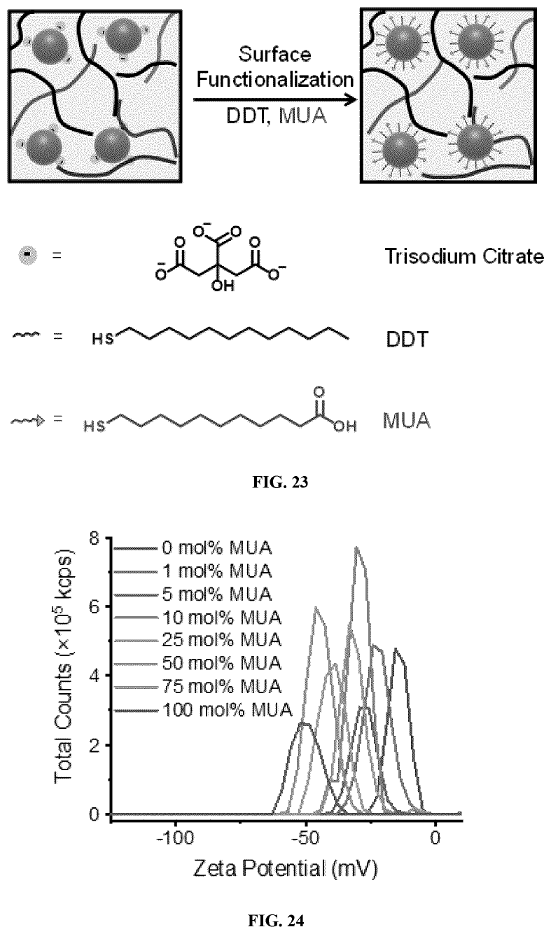

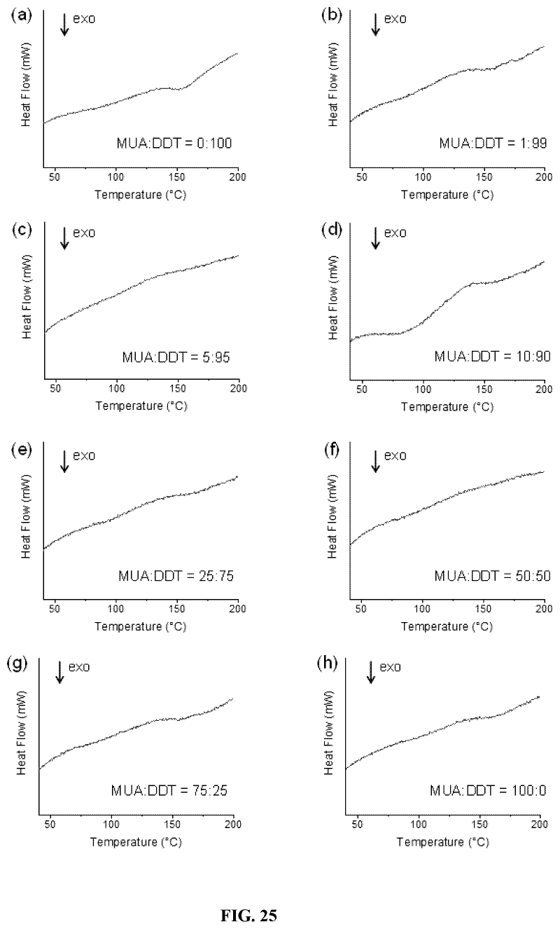

### Reassembly of Nanocomposites (FIG. 21)

No AuNPs aggregate after disassembly and reassembly.

### Non-Limiting Conclusion

Phase transfer of AuNPs can be achieved by the steric effects from polymer adsorption.

Functionalized AuNPs act as crosslinkers within polymer matrix, increasing the glass transition temperature with better mechanical properties.

Mechanical tests (e.g. modulus and stress-relaxation) will be performed.

This work can be extended to different particles (e.g. silica), different particle size and shape, different ligand density and length to tune nanocomposite properties.

### Example 7

Non-Limiting Exemplary Building Blocks and their Derivatives for Polymer Nanocomposites

| Nanoparticle | H-Bonding | | |
|---|---|---|---|
| Composition | Interaction | Ligand | Polymer |
| Gold/Silver | —COOH/ | 11-mercaptoundecanoic acid, | polyurethane, polyethylene |
| | —NH₂/ | methyl 3-mercaptopropionate | terephthalate, Nylon, |
| Silica | —OH and | (3-aminopropyl) trimethoxy | polycarbonates, |
| | amide/C═O | silane | polyacrylamides, |
| Carbon | | acid cutting (—COOH), | polyacrylates, poly(acrylic |
| Nanotube | | electrophilic addition (C═O), | acid), poly(vinyl alcohol) |
| | | reductive coupling (—NH₂) | |
| Iron Oxide | | catechol based molecule with | |
| | | target functional groups | |
| | | (—NH₂, —COOH, C═O) | |

Those skilled in the art will recognize, or be able to ascertain, using no more than routine experimentation, numerous equivalents to the specific substances and procedures described herein. Such equivalents are considered to be within the scope of this invention and are covered by the following claims.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A dynamic polymer nanocomposite comprising:
a nanoparticle;
a polymer comprising a hydrogen bonding moiety sidechain; and
a small molecule ligand, wherein the ligand comprises an anchoring moiety to functionalize the nanoparticle, a spacer region, and a hydrogen bonding moiety; and
a polymer comprising a hydrogen bonding moiety side chain complementary to the small molecule ligand hydrogen bonding moiety.

2. The nanocomposite of claim 1, wherein the nanoparticle is selected from the group consisting of a gold nanoparticle (AuNP), a silver nanoparticle (AgNP), a silica nanoparticle (SiNP), a carbon nanotube, an iron oxide nanoparticle, or a micellular nanoparticle.

3. The nanocomposite of claim 1, wherein the polymer is selected from the group consisting of polyacrylamide, a polyurethane, a polyethylene terephthalate, nylon, a polycarbonate, a polyacrylate, a poly(acrylic acid), or a poly(vinyl alcohol).

4. The nanocomposite of claim 3, wherein the polyacrylamide is poly(N,N′-dimethylacrylamide) (PDMA).

5. The nanocomposite of claim 1, wherein the polymer hydrogen bonding moiety side chain complementary to the small molecule ligand hydrogen bonding moiety is selected from the group consisting of —COOH, —NH₂, —OH, an amide, or a carbonyl.

6. The nanocomposite of claim 1, wherein the small molecule ligand linker anchoring moiety is selected from the group consisting of a thiol, a silane, a carboxylic acid, a carbonyl, or an amine.

7. The nanocomposite of claim 1, wherein the small molecule ligand is a catechol-based molecule.

8. The nanocomposite of claim 1, wherein the small molecule hydrogen bonding moiety is selected from the group consisting of —COOH, —NH₂, —OH, an amide, or a carbonyl.

9. The nanocomposite of claim 1, wherein the small molecule ligand is a thiol fatty acid or ester.

10. The method of claim 9, wherein the thiol fatty acid or ester is 11-mercaptoundecanoic acid or methyl 3-mercaptopropionate.

11. A method of synthesizing a dynamic polymer nanocomposite, the method comprising:
(a) dispersing at least one nanoparticle (NP) in an aqueous solution, thereby producing a NP dispersion;
(b) adding a polymer comprising a hydrogen bonding moiety sidechain into the NP dispersion thereby producing a polymer-NP mixture;
(c) removing the aqueous solution from the polymer-NP mixture;
(d) introducing an organic solvent into the polymer-NP mixture; and
(e) adding a small molecule ligand (MUA) into the polymer-NP, wherein the small molecule ligand comprises an anchoring moiety to functionalize the NP, a spacer region, and a hydrogen bonding moiety complementary to the polymer binding moiety, thereby assembling to form a dynamic polymer nanocomposite.

12. The method of claim 11, wherein the polymer is selected from the group consisting of a polyacrylamide, a polyurethane, a polyethylene terephthalate, nylon, a polycarbonate, a polyacrylate, a poly(acrylic acid), or a poly(vinyl alcohol).

13. The method of claim 12, wherein the polyacrylamide is poly(N,N′-dimethylacrylamide) (PDMA).

14. The method of claim 11, wherein the anchoring moiety is selected from the group consisting of a thiol group, a silanol group, a carboxylic acid group, a carbonyl group, or an amine group.

15. The method of claim 11, wherein the spacer region is selected from the group consisting of an alkyl chain, an ethylene glycol, or a poly(ethylene glycol).

16. The method of claim 11, wherein the organic solvent is chloroform.

17. The method of claim 11, wherein the nanoparticle comprises a gold nanoparticle (AuNP), a silver nanoparticle (AgNP), a silica nanoparticle (SiNP), a carbon nanotube, an iron oxide nanoparticle, or a micellular nanoparticle.

18. The method of claim 11, further comprising tuning the polymer nanocomposite glass transition temperature (T_{g}) by increasing the nanoparticle concentration in step (a) and the MUA concentration in step (e), thereby increasing the interfacial binding interactions and increasing the T_{g}.

19. The method of claim 11, further comprising tuning the polymer nanocomposite stress-relaxation rate by increasing the nanoparticle concentration in step (a) and the MUA concentration in step (e), thereby increasing the interfacial binding interactions and increasing the relaxation rate.

20. A polymer nanocomposite produced by the method of claim 11.
